(19) United States
(12) Patent Application Publication
(10) Pub. No.: US 2026/0360236 A1
(43) Pub. Date: Nov. 12, 2026

(54) PRESENCE-BASED SECURITY SYSTEM USING WIRELESS SENSING AND VIDEO CAPTURE

(71) Applicant: Ubiety Technologies, Inc., Chicago, IL (US)

(72) Inventors: Stephen Gordon, Amherst, MA (US); Keith Puckett, Chicago, IL (US); Keith A. Jentoft, Grand Marais, MN (US); Anna-Mi Widman, Chicago, IL (US); Cameron Miller, Chicago, IL (US)

(21) Appl. No.: 19/351,711

(22) Filed: Oct. 7, 2025

Related U.S. Application Data
(60) Provisional application No. 63/802,138, filed on May 8, 2025.

(51) Int. Cl. G08B 13/196; G08B 13/22; G08B 29/18; H04W 12/63; G06V 20/40; G06V 20/52; G06V 40/10

(52) U.S. Cl. CPC G08B 13/19602; G08B 13/19684; G08B 13/22; G08B 29/18; H04W 12/63; G06V 20/41; G06V 20/44; G06V 20/52; G06V 40/10

(57) ABSTRACT

A presence-based security system is disclosed. The system receives video from at least one camera and determines a number of persons depicted in the video. The system receives wireless signals from at least one sensor and generates presence information indicating potential presence of wireless devices and their identifiers. The system detects perturbations in the wireless signals and detects motion within a space based on the perturbations. The system determines whether known persons or unknown wireless devices are present by correlating the persons depicted, the presence information, and the detected motion. The system generates notifications indicating that known persons or unknown wireless devices are present, and optionally sends notifications to a user device.

### CROSS-REFERENCE TO RELATED APPLICATION

This application claims the benefit of U.S. Provisional Patent Application No. 63/802,138, filed May 8, 2025, which is incorporated herein by reference in its entirety.

### BACKGROUND

Traditional home security systems can use sensors, alarms, and monitoring devices to detect unauthorized entry or threats. Common components include door/window sensors, motion detectors, cameras, and control panels for arming or disarming. When triggered, these systems may sound alarms, notify monitoring stations, or alert owners via mobile apps. Smart home integration allows remote control and adds features like automated lighting, temperature control, and video surveillance.

However, conventional systems face challenges such as frequent false alarms caused by user error or equipment malfunction, which can result in unnecessary panic, wasted resources, or fines. They also rely on users to actively arm or disarm the system, making them vulnerable to human error and inconvenience. Additionally, increased complexity has led to higher installation and monitoring costs, making security less accessible for some consumers. As technology evolves, there is a need for more accurate, effective, and user-friendly home security solutions.

### BRIEF DESCRIPTION OF THE DRAWINGS

Detailed descriptions of implementations of the present technology will be described and explained through the use of the accompanying drawings.

FIG. 1 is a block diagram that illustrates an example presence-based security system that can implement aspects of the present technology.

FIG. 2 is a block diagram that illustrates an architecture of an example presence-based security system.

FIG. 3 is a block diagram that illustrates a distributed architecture of an example presence-based security system, according to aspects of the present disclosure.

FIG. 4 is a drawing that illustrates example mobile device interfaces displaying security system notifications and controls, according to aspects of the present disclosure.

FIG. 5 is a drawing that illustrates example mobile device interfaces displaying security system notifications, according to aspects of the present disclosure.

FIG. 6 is a drawing that illustrates an example video monitoring interface for a security system, according to aspects of the present disclosure.

FIG. 7 is a drawing that illustrates an example video monitoring interface for a security system, according to aspects of the present disclosure.

FIG. 8 is a flowchart illustrating an example process for presence detection using wireless sensing and video, according to aspects of the present disclosure.

FIG. 9 is a flowchart illustrating an example process for event classification and response generation, according to aspects of the present disclosure.

FIG. 10 is a flowchart illustrating an example process for presence detection and response generation, according to aspects of the present disclosure.

FIG. 11 is a block diagram that illustrates an example presence-based security system that can implement aspects of the present technology.

FIG. 12 is a flowchart illustrating an example process for correlating video-derived person counts with wireless-based device presence and motion, according to aspects of the present disclosure.

FIG. 13 is a flowchart illustrating an example process for proximity determinations based on signal strength, according to aspects of the present disclosure.

FIG. 14 is a flowchart illustrating an example process for analyzing received signal strength indicator trends of wireless signals, according to aspects of the present disclosure.

FIG. 15 is a block diagram that illustrates an example artificial intelligence system that can implement aspects of the present technology.

FIG. 16 is a block diagram that illustrates an example computer system in which at least some operations described herein can be implemented.

The technologies described herein will become more apparent to those skilled in the art from studying the Detailed Description in conjunction with the drawings. Embodiments or implementations are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Home security systems can protect against threats such as break-ins, fires, and other emergencies using sensors, alarms, and monitoring devices that detect unauthorized entry or hazards. Their goals are to safeguard occupants, deter intruders, and alert users or authorities before incidents escalate. However, challenges persist with existing systems. False alarms remain common, often triggered by pets, environmental factors, or user error, leading to wasted resources, panic, or fines. Many systems are complex, requiring manual arming and disarming, which is prone to oversight. Criminals are increasingly sophisticated, outpacing traditional measures. Privacy concerns also arise as smart home integration exposes systems to data risks and potential hacking.

Conventional systems rely on door/window sensors, motion detectors, and control panels. When armed, a triggered sensor activates an alarm, sometimes alerting a monitoring service. Cameras have become common, and smart features now allow remote control via mobile apps to arm/disarm, view feeds, and receive alerts. However, reliance on manual operation is a key weakness, leading to false alarms or unprotected homes. Binary armed/disarmed modes fail to accommodate real household routines, while simple sensors cannot distinguish harmless activity. These limitations reduce reliability and erode user confidence in conventional systems.

This document discloses methods, systems, and apparatuses for presence-based security systems that use video capture and sensing of wireless signals. The systems disclosed herein provide improvements to home protection, addressing the shortcomings of traditional methods. The disclosed systems use a combination of wireless signal sensors, cameras, and/or smart devices to create a security network. Unlike conventional systems that rely solely on motion detection or contact sensors, the disclosed systems scan for wireless signals emitted by wireless devices carried by individuals. The systems can distinguish between known family members, expected visitors, and potential intruders. The integration of video monitoring with wireless sensing provides a more nuanced understanding of activities within and around the home than traditional security systems. Moreover, the disclosed systems can use artificial intelligence (AI) to analyze patterns and make intelligent decisions, reducing false alarms and providing more meaningful alerts to homeowners than traditional security systems.

The approaches to home security disclosed herein address the problems associated with traditional systems. By constantly or periodically monitoring for the presence of known and unknown wireless devices, the disclosed systems prevent the need for manual arming and disarming, reducing the risk of human error. The ability to recognize familiar devices means that family members and authorized visitors can move more freely without triggering alarms, while still maintaining a high level of security against unknown entities. The integration of AI-powered video analysis with wireless sensing enables more accurate event classification than traditional security systems, reducing false alarms. The disclosed systems’ ability to adapt to household routines and visitor patterns creates a more flexible and user-friendly security solution than traditional security systems. Additionally, the use of existing smart home devices and wireless signals means that installation can be less intrusive and more cost-effective than traditional security systems, making advanced security more accessible to a broader range of consumers than traditional security systems.

The disclosed systems can recognize different types of electronic devices and their typical behavior patterns. The learning process can include collecting information from Wi-Fi, Bluetooth, or cellular signals sent out by various devices, such as phones, tablets, or laptops. The systems pay attention to how often these devices send out signals, what kind of information is in these signals, and how strong the signals are. By studying these patterns, the systems can generate a digital fingerprint for each type of device. This knowledge is then used to train a computer system to quickly identify and count the number of devices present in a home or nearby area. The computer system does not need to connect to wireless devices or invade an individual’s privacy. Instead, the computer system listens for the wireless signals that wireless devices naturally broadcast, using this information to build a more accurate picture of people that are around and whether there might be any security concerns.

In some implementations, the disclosed systems implement localized presence detection by utilizing sensors integrated within or proximate to camera units to create spatially-aware monitoring zones. The system can use received signal strength indicator (RSSI) measurements from detected wireless devices to establish proximity relationships between individuals and specific camera locations. For example, when a camera detects motion or visual activity, the system can analyze contemporaneous signals to determine if known or unknown wireless devices are present within the localized detection range of that particular camera. The system can process Bluetooth advertisements, Wi-Fi probe requests, and/or other wireless transmissions to extract unique device identifiers, while these identifiers are correlated with a database of authorized devices. AI algorithms may be employed to establish RSSI threshold boundaries that define the localized presence zone around each camera, enabling the system to distinguish between devices that are merely within the broader property coverage area versus those that are specifically proximate to the camera location where the visual event occurred.

A system can determine device approach or departure patterns by monitoring RSSI trends of signals detected by camera-integrated sensors. The system can process temporal sequences of RSSI measurements, applying signal processing algorithms to detect directional movement patterns relative to the camera position. As a wireless device approaches a monitored entrance, the system observes increasing RSSI values over time, while departing devices exhibit decreasing signal strength measurements. AI models may be trained to recognize characteristic RSSI signature patterns associated with typical approach and departure behaviors, enabling the system to categorize detected movements as ingress or egress events. This directional movement analysis provides contextual information that enhances the system's ability to assess the nature and urgency of detected security events, particularly when combined with visual motion detection and device identification data.

The benefits and advantages of the implementations described herein include a reduction in false alarms and improved accuracy in detecting potential security threats. The disclosed presence-based security systems use a combination of wireless signal detection and video analysis to create a more comprehensive understanding of events in and around a home compared to traditional security systems. This means fewer false alarms triggered by pets, environmental factors, or harmless activities. The disclosed systems’ abilities to recognize known devices associated with family members or authorized visitors enables a more nuanced approach to security than traditional security systems, eliminating the need for repeated manual arming and disarming. Additionally, the disclosed systems’ learning capabilities mean they become more accurate over time, adapting to the unique patterns and routines of each household. The intelligent event classification and threat assessment capabilities of the disclosed systems enable more targeted and efficient responses to potential security issues than traditional security systems. This not only improves the overall effectiveness of the disclosed systems but can also lead to faster and more appropriate responses from emergency services when needed, potentially saving crucial time in real emergency situations.

### Terminology

A “known person” refers to an individual who has been previously identified and authorized within the security system, typically associated with one or more registered wireless device identifiers stored in the system's database of approved users.

An “unknown wireless device” refers to a wireless communication device that emits detectable wireless signals but lacks corresponding identification data in the system's database of authorized devices, indicating potential presence of unrecognized individuals.

A “known wireless device” refers to a wireless communication device whose unique identifier, such as MAC address or device signature, has been previously registered and stored in the system's database of authorized devices.

As used herein, the term "occupancy status" refers to information describing one or more individuals or one or more wireless devices that are present at a location, or within or around a monitored space.

“Presence information” may refer to data indicating the detection, identification, location, movement patterns, or occupancy status of individuals or wireless devices within and around a monitored area based on sensor inputs, captured video, and analysis algorithms.

“Perturbations” in wireless signals may refer to measurable changes in wireless signal characteristics including amplitude variations, phase shifts, frequency deviations, multipath reflections, signal attenuation, or propagation delays caused by objects or movement within the monitored environment.

“Motion” may refer to physical movement or displacement of objects, individuals, or wireless devices within and around a monitored area that causes detectable changes in sensor readings, wireless signals, or visual data captured by the system.

A “trend” in RSSI values refers to temporal patterns in RSSI measurements that indicate directional changes in wireless signal amplitude over time, enabling determination of device approach or departure movements.

As used herein, the term "event" may refer to any detectable occurrence or change in state within and around the monitored space that is of potential security interest, including but not limited to motion, presence, entry, exit, or device activity.

A “threat level” refers to a quantitative or qualitative assessment of potential security risk associated with detected events, ranging from low to high urgency based on analysis of presence, motion, and contextual factors.

A “monitoring service” refers to a professional security service that receives, analyzes, and responds to alerts from security systems, providing human oversight and coordination with emergency responders when necessary for detected events.

An “emergency service” refers to public safety organizations including police, fire departments, or medical services that respond to urgent situations and can be automatically contacted by the security system during high-threat events.

A “location” refers to a physical area, property, building, or defined space (such as a home entrance) that is monitored by the security system using wireless sensors, cameras, and other detection devices for presence and activity surveillance.

A “space” refers to a physical area under surveillance using wireless sensors and/or cameras. A space can include residential properties, commercial buildings, outdoor perimeters, specific rooms, parking lots, warehouses, retail stores, office complexes, or industrial facilities.

“Proximate” refers to a spatial relationship indicating that a wireless device or individual is within a defined threshold distance or signal strength range relative to a specific sensor or camera position.

“Linger time” refers to the duration that a wireless device remains within a defined proximity zone or maintains detectable signal strength above predetermined thresholds, indicating sustained presence at a location.

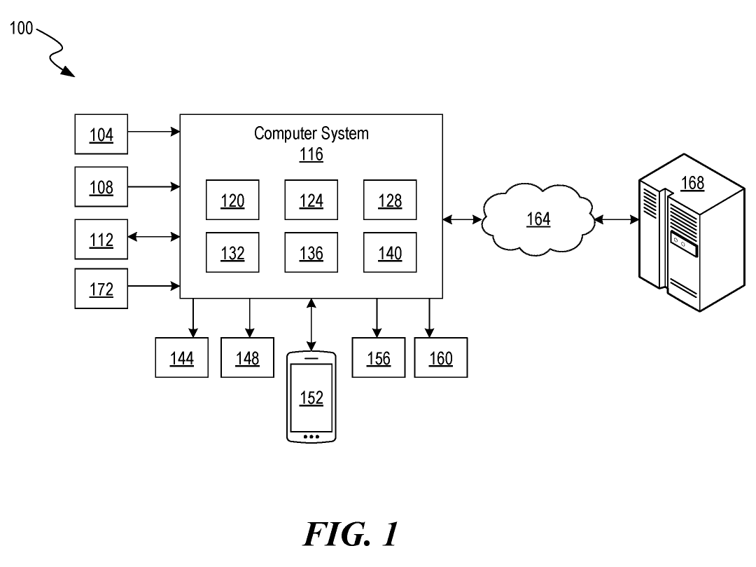

FIG. 1 is a block diagram that illustrates an example presence-based security system 100 that can implement aspects of the present technology. The presence-based security system 100 can include multiple interconnected elements arranged in a hierarchical structure. For example, wireless (e.g., RF) sensors 104, wireless (e.g., RF) receivers 172, cameras 108, and alarm-based functionalities 112 feed data into a central computer system 116. This computer system 116 can house several processing modules, including a data aggregation module 120, presence determination module 124, arrival detection module 128, correlation and sensor fusion module 132, event classification module 136, and threat level assessment module 140. Each module described herein can be implemented using computer hardware, software, firmware, or a combination thereof. The computer system 116 can interface with external devices and services using a network 164, connecting to a mobile device 152, an emergency service 156, and a cloud server 158. Additionally, the system 116 can control various smart devices such as smart locks 144, smart lights 148, and/or speakers 160 based on its assessments and determinations.

The presence-based security system 100 leverages wireless sensing technology in conjunction with video analysis and intelligent data processing. The wireless sensors 104 detect and characterize the presence and characteristics of wireless signals for monitoring and security. The wireless sensors 104 can include radio frequency (RF) sensors, Infrared sensors, Visible Light Communication (VLC) sensors, Free-Space Optical (FSO) sensors, Ultraviolet (UV) sensors, acoustic (e.g., Ultrasonic) sensors, Near-Field Communication (NFC) sensors, or a combination thereof. The presence-based security system 100 can also include wireless receivers 172 that receive and decode different types of wireless signals, enabling communication and data transfer. One or more wireless sensors and one or more receivers can be part of the same hardware module and/or a sensor can be included within the hardware of a receiver. The sensors 104 are capable of detecting various types of wireless signals, including but not limited to Wi-Fi, Bluetooth, cellular, and Zigbee signals.

The receivers 172 are used to identify wireless devices carried by individuals entering or present within and around the monitored space, as well as detecting motion using perturbations in wireless signals. The sensors 104 and/or receivers 172 can be used to detect not only that wireless devices are present but also sense perturbations in wireless signals that may indicate motion. This dual functionality enables the system 100 to detect movement even in areas where traditional motion sensors might be ineffective or impractical to install. The sensors 104 and/or receivers 172 may be constructed using specialized antennas and signal processing hardware capable of detecting and analyzing a wide spectrum of signals.

The sensors 104 can include thermal sensors, which measure wireless power by sensing temperature increases in thermally conductive materials heated by wireless signals. Diode sensors can rectify wireless signals into DC voltage, with the voltage being proportional to the wireless signal's power, enabling measurement of intensity. Calibrated sensors, which combine thermal or diode methods with additional circuitry, can be used to measure wireless signal power over specific frequency ranges. RF-EMF sensors can measure the strength of electromagnetic fields in specific frequency bands. Some sensors measure the dielectric constant of a material, as used in wireless level sensors.

The one or more cameras 108 are placed to capture video data of the location. These cameras 108 provide visual information that enhances the ability to detect and classify events. The cameras 108 may incorporate advanced features such as night vision, wide-angle lenses, or pan-tilt-zoom capabilities to provide visual coverage of the monitored space. The cameras 108 can use high-resolution image sensors and sophisticated image processing algorithms to enhance the quality and usefulness of the captured video data. The presence-based security system 100 can also incorporate alarm-based functionalities 112, which may include traditional security system components such as door sensors, window sensors, or smoke detectors. These alarm-based functionalities 112 offer additional data points for security monitoring.

The computer system 116 serves as a central processing unit for incoming data and decision-making processes. The computer system 116 may be implemented using high-performance processors, ample memory, and specialized hardware accelerators to implement the data processing and analysis tasks required for real-time security monitoring. The software running on this computer system 116 may incorporate AI and machine learning algorithms to improve its ability to detect and classify security events.

The computer system 116 can include modules that can work together to analyze data and generate appropriate responses. The data aggregation module 120 may employ data fusion techniques to combine information from disparate sources, normalizing and synchronizing data streams to create a coherent input for subsequent processing stages. The data aggregation module 120 receives and combines inputs from the sensors 104 and/or receivers 172, cameras 108, and alarm-based functionalities 112, creating a unified data stream for further processing. The presence determination module 124 uses the aggregated data to determine that individuals are present within or around the monitored space. This module may employ algorithms to distinguish between different types of presences, such as known residents, authorized guests, or potential intruders. For example, the presence determination module 124 analyzes data from the receivers 172 to detect wireless devices and their unique identifiers like MAC addresses. This information is correlated with a database of known devices associated with authorized users. The presence determination module 124 can also process motion detection data from wireless signal perturbations and video feeds from cameras.

By fusing these data streams, the presence determination module 124 can infer that known and/or unknown individuals are present. The presence determination module 124 can consider factors such as the number of detected devices, their movement patterns, and visual confirmation of persons that are present from cameras. The presence determination module 124 can use machine learning algorithms to improve accuracy over time, learning to distinguish between different types of presence scenarios and reduce false positives.

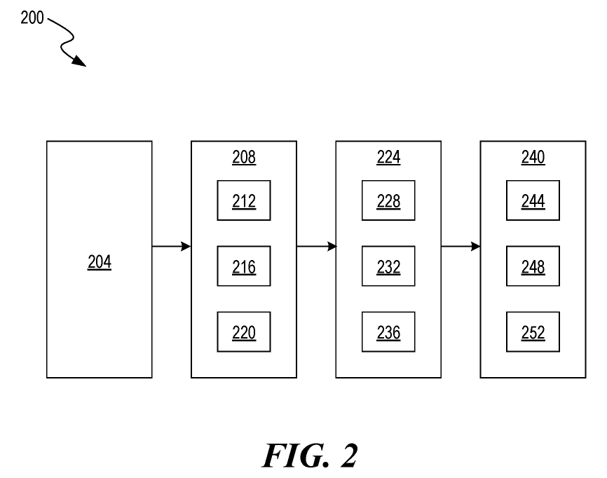

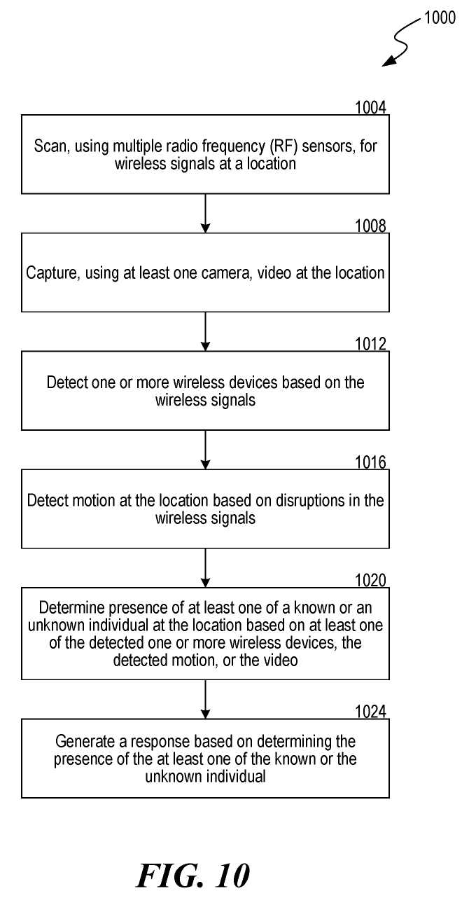

The computer system can distinguish between known and unknown devices using the device identification module 212 in conjunction with the sensors 104 and/or receivers 172. As illustrated in FIGS. 1 and 2 , the receivers 172 scan for wireless signals at the location, detecting various wireless devices. The device identification module 212 analyzes the detected signals, comparing them against a database of known device signatures stored in the system's memory. The presence determination module 124 processes this information to establish whether the detected devices are known or unknown. The correlation and sensor fusion module 132 may further integrate this data with inputs from cameras 108 and other sensors to provide a more comprehensive assessment. The event classification module 136 can categorize the detected presence as either a known or unknown individual based on the device identification. This multi-layered approach, leveraging both wireless sensing and video data as also depicted in FIG. 10, enables the system to accurately distinguish between known and unknown devices, enhancing its ability to assess potential security threats and determine appropriate responses.

The arrival detection module 128 works in tandem with the presence determination module 124. The arrival detection module 128 detects persons arriving at a location, whether they are expected or unexpected. The presence determination module 124 and arrival detection module 128 can use probabilistic models and pattern recognition algorithms to identify and distinguish between different types of presences and arrivals. For example, the arrival detection module 128 relies on input from the receivers 172, which detect wireless signals from devices entering the property's range. The arrival detection module 128 compares newly detected device signatures against a database of known devices to identify potential new arrivals. The arrival detection module 128 can correlate the wireless data with motion detection from cameras 108 and perturbations in wireless signals to confirm physical movement. Machine learning algorithms can be used to improve accuracy over time, learning to distinguish between regular visitors and new arrivals. By integrating data from various sensors and applying intelligent analysis, the arrival detection module 128 can quickly and accurately identify when new individuals enter the monitored space.

The correlation and sensor fusion module 132 synthesizes data from multiple sources. This module may use techniques such as data fusion and machine learning to correlate information from sensors 104 and/or receivers 172, cameras, and alarm functionalities, creating a more comprehensive and accurate picture of the security situation than traditional security systems. The correlation and sensor fusion module 132 provides context-aware security monitoring. This module may employ advanced techniques such as Kalman filtering, Bayesian networks, or deep learning models to fuse data from multiple sensors, reducing uncertainty and improving the overall reliability of the system's assessments.

The event classification module 136 takes the correlated data and categorizes various events occurring within and around the monitored space. This classification process may involve identifying normal activities, potential security threats, or anomalous behaviors based on predefined rules or machine learning algorithms. The event classification module 136 can use a combination of rule-based systems and machine learning classifiers to categorize detected events. This module may be trained on extensive datasets of normal and anomalous activities, enabling it to accurately distinguish between benign events and potential security threats.

The threat level assessment module 140 evaluates the classified events in conjunction with other contextual information to determine the potential risk level associated with each event. This assessment may consider factors such as the time of day, the identity of individuals present, and historical patterns of behavior. The threat level assessment module 140 may incorporate risk analysis models and decision-making algorithms to evaluate the severity of classified events and determine appropriate response levels. For example, it analyzes the event type classified by module 136, examines presence information from module 124, and assesses correlations between motion detection and device arrivals from module 132.

The module 140 can incorporate historical data and patterns to contextualize current events, potentially utilizing machine learning algorithms to weigh these factors. It considers the event's timing and location within and around the property, as well as the number and types of unknown devices detected. Based on this multifaceted analysis, the module assigns an appropriate threat level, enabling the system to respond to potential security risks. Based on these assessments, the system 100 can initiate appropriate responses using various connected devices and communication channels.

The computer system can determine whether the detected motion corresponds to a known or an unknown wireless device by utilizing the correlation and sensor fusion module 132 in conjunction with the device identification module 212. As illustrated in FIGS. 1 and 2 , data from sensors 104 and/or receivers 172 and cameras 108 is analyzed to detect motion and wireless signals. The presence determination module 124 cross-references detected wireless device signatures with a database of known devices. Simultaneously, the event classification module 136 categorizes the detected motion. The threat level assessment module 140 then evaluates this correlated information to assign a threat level. For instance, motion detected in conjunction with an unknown wireless device may be assigned a higher threat level compared to motion associated with a known device. This multi-layered analysis, leveraging both wireless and video data as also shown in FIG. 10, enables the system 100 to make nuanced threat assessments based on the correspondence between detected motion and wireless device identification, enhancing the accuracy and contextual understanding of potential security events.

The computer system can also interface with smart locks 144 and smart lights 148. These connected devices enable the system 100 to take automated actions in response to detected events or threats. For instance, the system 100 may automatically lock doors when an unknown presence is detected or activate lights to deter potential intruders. A speaker 160 can also be integrated into the system 100, enabling audible alerts or two-way communication in security situations. The integration with smart locks 144 and smart lights 148 provides physical security responses. These smart devices may be connected using protocols such as Z-Wave, Zigbee, or Wi-Fi, enabling communication with the central computer system. The speaker 160 may be a high-quality audio device capable of producing clear and loud alerts or facilitating two-way communication in emergency situations. Alerts are sometimes to as notifications herein.

The presence-based security system 100 interfaces with external components using a network 164. This network connectivity enables communication with a mobile device 152, enabling users to receive notifications, view live video feeds, and control system functions remotely. The network 164 that connects the presence-based security system 100 to external devices and services can use advanced encryption and security protocols to enable the integrity and confidentiality of transmitted data. This network 164 may support multiple communication technologies, including Wi-Fi, cellular, and potentially low-power wide-area network (LPWAN) protocols for extended range and reliability. A mobile device interface may be implemented using a dedicated smartphone application, providing users with intuitive controls and real-time access to security information. This application may incorporate features such as push notifications, live video streaming, and secure authentication mechanisms such that only authorized users can access and control the presence-based security system 100. In cases of high-threat events, the presence-based security system 100 can directly contact an emergency service 156, providing the service with information about the nature of the security situation and the layout of the property. The system's ability to directly contact the emergency service 156 may be facilitated by integration with emergency response application programming interfaces (APIs) or dedicated communication channels. This feature could potentially reduce response times in critical situations by automatically providing first responders with detailed information about the nature of the security event and the layout of the property.

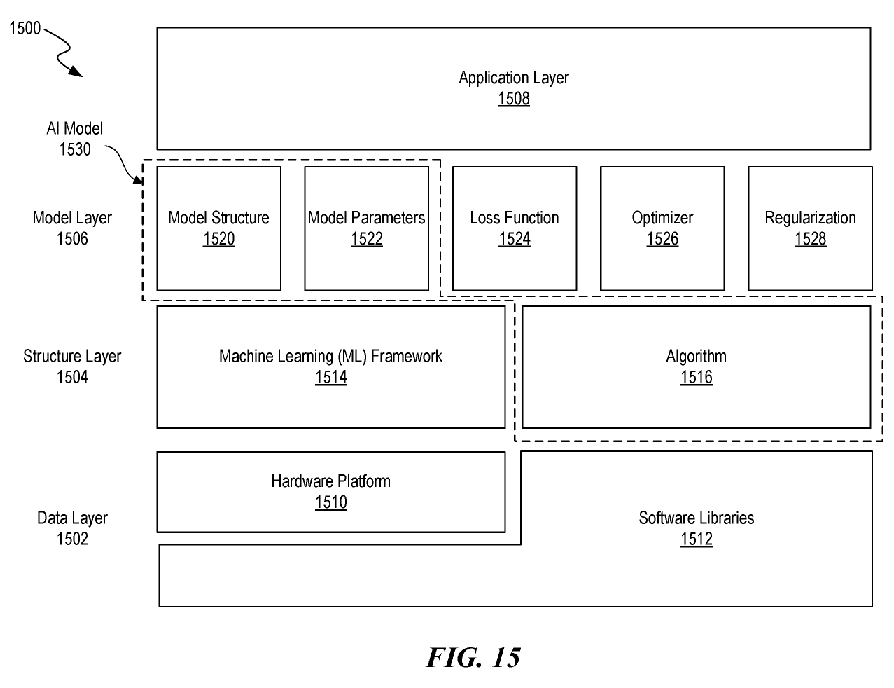

To enhance processing capabilities and enable advanced features, the presence-based security system 100 can leverage a cloud server 168. The cloud integration enables offloading of computationally intensive tasks, storage of historical data, and potential integration with broader security networks or AI systems, e.g., the AI system 1500 illustrated and described in more detail with reference to FIG. 15. The cloud server 168 may provide scalable computing resources and storage capabilities, enabling advanced analytics, long-term data retention, and potential integration with broader security networks. The cloud infrastructure may employ containerization and microservices architectures to provide flexibility, scalability, and reliability in processing security-related data and executing complex algorithms.

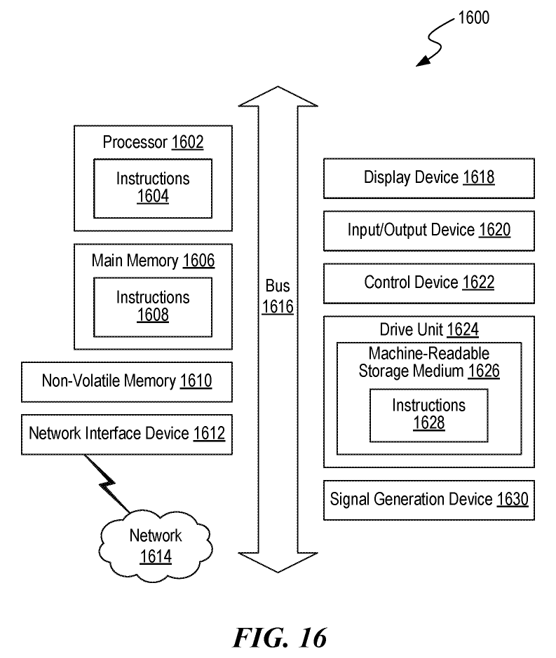

FIG. 2 is a block diagram that illustrates an example architecture of a presence-based security system 200. The example architecture includes multiple modules that can be arranged in a sequential flow, building upon the data and analysis provided by the preceding module. Each module can be implemented using hardware, firmware, software, or a combination thereof. The presence-based security system 200 can be implemented using components of the example computer system 1600 illustrated and described in more detail with reference to FIG. 16.

The data collection module 204 is communicably coupled to a data processing module 208, which incorporates device identification, motion analysis, and video processing capabilities. The intelligence module 224 aggregates presence information, classifies events, and determines threat levels. The response management module 240 generates alerts, controls smart devices, and interfaces with emergency services. Each module can contain multiple sub-components that transform raw sensor data into actionable security insights and responses.

The data collection module 204 gathers raw sensor data from various sources such as wireless sensors, cameras, and other connected devices. The data collection module 204 is an input mechanism for the presence-based security system 200. This module may incorporate multiple wireless sensors and/or receivers configured to scan for wireless signals in and around the monitored space. Additionally, the data collection module may include one or more cameras placed to capture video data of the location. These cameras provide visual information that complements the sensor data, enabling more accurate presence detection and event classification than traditional security systems.

The collected data flows into the data processing module 208, which houses three sub-components: a device identification module 212, a motion analysis module 216, and a video processing module 220. These modules work in tandem to extract meaningful information from the raw sensor data, identifying wireless devices, analyzing motion patterns, and processing video feeds. The data processing module 208 is responsible for refining and analyzing the raw data collected in the previous stage. The device identification module 212 processes the wireless signals detected by the sensors to identify specific wireless devices. This module may employ advanced algorithms to distinguish between different types of devices and associate them with known or unknown individuals. The motion analysis module 216 focuses on detecting and interpreting motion within and around the monitored space. This module can use both the sensor data and video data to identify perturbations in wireless signals that indicate movement, as well as analyze visual motion cues from the camera feeds. The video processing module 220 interprets visual data from the cameras, potentially employing computer vision techniques to identify objects, individuals, and activities within the captured video streams.

The processed data then feeds into the intelligence module 224, where higher-level analysis and decision-making occur. This module includes a presence information module 228, which combines data from multiple sources to determine the presence and identity of individuals within and around the monitored space. An event classification module 232 categorizes detected events based on the aggregated presence information and other contextual data. A threat level assessment module 236 evaluates the classified events to determine potential security risks and assign appropriate threat levels. The intelligence module 224 represents the analytical capabilities of the presence-based security system. The presence information module 228 combines data from multiple sources, including the identified wireless devices, detected motion, and video analysis, to build an understanding of who is present in or entering the monitored space. This module may maintain a database of known wireless devices associated with authorized users, enabling it to distinguish between familiar and unfamiliar presences. The event classification module 232 takes the aggregated presence information and classifies various events occurring within and around the monitored space. This classification process may involve identifying normal activities, potential security threats, or anomalous behaviors based on predefined rules or machine learning algorithms. The threat level assessment module 236 evaluates the classified events in conjunction with other contextual information to determine the potential risk level associated with each event. This assessment may consider factors such as the time of day, the identity of individuals present, and historical patterns of behavior.

The response management module 240 translates the intelligence gathered in previous stages into actionable responses. This module comprises an alert generation module 244, responsible for creating and dispatching notifications to relevant parties such as property owners or security personnel. A device control module 248 manages the activation and deactivation of connected smart devices like locks and lights based on the system's assessments. An emergency services interface module 252 facilitates direct communication with first responders when necessary, providing them with information about the security situation.

The response management module 240 is responsible for translating the system's intelligence into appropriate actions and notifications. The alert generation module 244 creates targeted notifications based on the classified events and threat assessments. These alerts may be sent to various recipients, including property owners, security personnel, or other designated contacts, using multiple channels such as mobile applications, text messages, or email. The device control module 248 manages the activation and deactivation of connected smart devices within and around the monitored space. This may include automatically locking smart locks when an unknown presence is detected, activating lights to deter potential intruders, or adjusting other home automation systems based on the security situation. The emergency services interface module 252 provides a direct link to first responders when critical security events are detected. This module can automatically contact police, fire departments, or medical services, providing them with detailed information about the nature of the emergency and the layout of the property.

The presence-based security system 200 can determine whether a known wireless device is present or approaching a property using wireless sensors and/or receivers to scan for wireless signals at the location. The device identification module 212, shown in FIG. 2, can analyze the detected signals to identify known device signatures stored in a database. Concurrently, a presence determination module processes this information to establish that known devices are present. Based on this determination, the presence-based security system 200 can determine the occupancy status at the location. The occupancy status is determined using data from various sensors, including wireless sensors and/or cameras. A correlation and sensor fusion module integrates the wireless device data with inputs from cameras and other sensors to provide an assessment of occupancy. The event classification module may further refine this determination by categorizing the detected presence as either a known or unknown individual. This multi-layered approach, leveraging both wireless sensing and video data, enables the system to accurately determine occupancy status, enhancing its ability to differentiate between various security scenarios.

The architecture illustrated in FIG. 2 enables a more sophisticated and adaptive approach to security monitoring than traditional security systems. By processing data through multiple layers of analysis, the system 200 can make informed decisions about potential security threats and respond accordingly. For example, when an unknown wireless device is detected approaching the property, the system can correlate this information with video data to classify the event. If the presence is determined to be unauthorized, the system can automatically lock doors, activate deterrent measures like flashing lights, and send alerts to the property owner and security services. The modular nature of the architecture enables flexibility and scalability in implementation. Additional sensors or data sources can be integrated into the data collection module, while new analytical capabilities can be added to the intelligence module as technology evolves. This extensibility enables the presence-based security system 200 to adapt to emerging security challenges and incorporate advanced features over time.

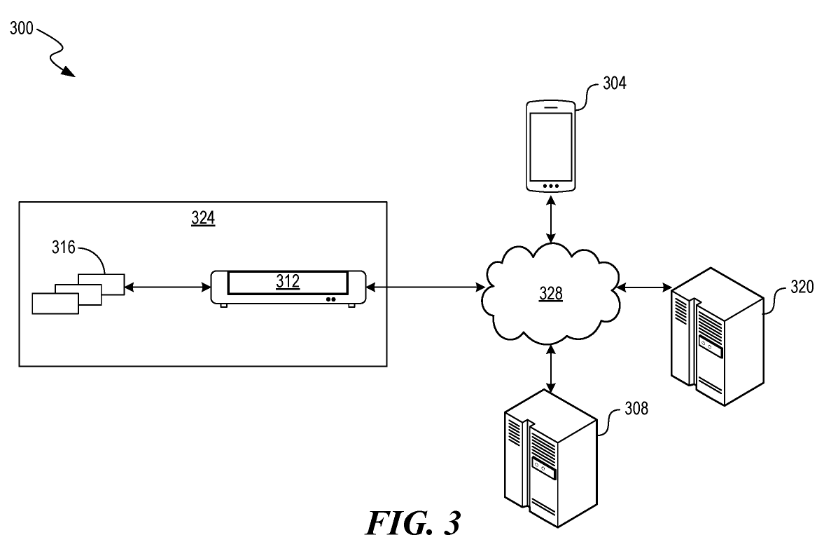

FIG. 3 is a block diagram that illustrates an example distributed architecture of a presence-based security system 300, according to aspects of the present disclosure. The presence-based security system 300 can include components interconnected using a network infrastructure 328. A computer system 312 can serve as the central processing unit. The computer system 312 interfaces with multiple smart devices 316, enabling control and data collection from various sensors and connected devices throughout the monitored space 324.

The monitored space 324 (or “space”) refers to a physical area under surveillance by security sensors and cameras. The monitored space can include residential properties, commercial buildings, outdoor perimeters, specific rooms, parking lots, warehouses, retail stores, office complexes, or industrial facilities where presence detection and security monitoring occur. The network infrastructure 324 refers to the interconnected hardware and software components that enable communication between devices. The network infrastructure 328 may include routers, switches, wireless access points, ethernet cables, fiber optic connections, cellular towers, internet service providers, cloud servers, firewalls, and network protocols facilitating data transmission.

A mobile device 304 can provide user interaction and remote access to the presence-based security system 300, communicating with both the computer system 312 and a security service provider 308. The security service provider 308 acts as an intermediary, coordinating with an alarm and video monitoring service 320 to process and respond to security events detected by the presence-based security system 300.

The computer system 312 can serve as a central hub for data processing, analysis, and decision-making. The computer system 312 may be implemented using high-performance processors, ample memory, and specialized hardware accelerators to implement the complex computations required for real-time security monitoring. The computer system 312 is designed to execute algorithms for presence detection, event classification, and threat assessment based on inputs from various sensors and devices throughout the monitored space 324.

The smart devices 316 may include a variety of sensors, cameras, and/or controllable devices. The smart devices 316 can also include wireless sensors and/or receivers configured to scan for wireless signals at the location. The sensors and/or receivers within the smart devices 316 can be used to identify wireless devices carried by individuals entering or present within the monitored space 324, as well as be used to detect motion using perturbations in wireless signals. Additionally, the smart devices 316 may include cameras that capture video data, providing visual information to complement the wireless sensor data and enhance the system's ability to detect and classify events.

The mobile device 304 can interface between the users and the presence-based security system 300. This mobile device 304 may be a smartphone, tablet, or other portable device capable of running a dedicated application for system control and monitoring. Using this mobile device 304, users can receive notifications, view live video feeds, and control various aspects of the security system remotely. The mobile device 304 communicates with the computer system 312, enabling real-time updates and control, as well as with the security service provider 308, potentially enabling additional services or support.

The security service provider 308 can be a cloud-based service or a dedicated server infrastructure that provides additional processing power, storage, and coordination capabilities. The security service provider 308 can interface with the computer system 312 and/or the mobile device 304, acting as an intermediary to enhance the system's functionality and provide professional monitoring services. It may employ advanced encryption and security protocols to provide integrity and confidentiality of transmitted data.

The alarm and video monitoring service 320 provides professional monitoring and response to security events. The alarm and video monitoring service 320 receives processed data and alerts from the security service provider 308, enabling trained personnel to assess situations and take appropriate actions, such as contacting the property owner or dispatching emergency services if necessary. The distributed architecture of the presence-based security system 300 enables flexible deployment and scalability. The computer system 312 may be located on-premises, providing local processing and reduced latency for critical security functions. Alternatively, some or all of the processing may be offloaded to the security service provider 308, leveraging cloud computing resources for enhanced capabilities and easier system updates.

The smart devices 316 connected to the computer system 312 can form a sensor network across the monitored space 324. These devices may include not only sensors and cameras but also traditional security system components such as door sensors, window sensors, or smoke detectors. The integration of these diverse sensors enables the presence-based security system 300 to gather a rich set of data for analysis and event detection.

The computer system 312 can include software modules that enable functionality of the presence-based security system 300. These may include a data aggregation module that combines inputs from the various smart devices 316, a presence determination module that analyzes the aggregated data to identify and track individuals within and around the monitored space 324, and an event classification module that categorizes detected activities based on predefined rules or machine learning algorithms. Each module can be implemented using hardware, firmware, software, or a combination thereof. The modules can be implemented using components of the example computer system 1600 illustrated and described in more detail with reference to FIG. 16. By identifying and tracking wireless devices associated with individuals, the presence-based security system 300 can distinguish between known residents, authorized guests, and potential intruders. This capability enables personalized security responses, such as automatically disarming the system for recognized family members or triggering enhanced monitoring for unfamiliar presences.

The integration of video data from cameras within the smart devices 316 enhances the system's ability to classify events and assess threats. Computer vision algorithms running on the computer system 312 or the security service provider 308 can analyze video feeds in real-time, identifying objects, individuals, and activities. This visual information, when combined with sensing data, provides a more comprehensive understanding of security situations than traditional security systems. The mobile device 304 interface offers users control and awareness of the presence-based security system 300. A dedicated application running on the mobile device 304 may provide features such as live video streaming, instant alerts for detected events, and the ability to arm or disarm the presence-based security system 300 remotely. Users can also use the mobile device 304 to configure system settings, define security zones, or add new authorized devices to the system's database.

The security service provider 308 can function as a bridge between the local system components and broader security networks. It may provide additional processing power for computationally intensive tasks, such as running complex machine learning models for event classification or threat assessment. The security service provider 308 can also facilitate system updates, such that the presence-based security system 300 remains current with the latest security features and threat detection capabilities. The alarm and video monitoring service 320 adds a human intelligence layer to the automated security processes. Trained operators can review alerts and video feeds, providing an additional level of verification before taking action. This service can be particularly valuable in complex security situations where human judgment is necessary to distinguish between genuine threats and false alarms.

In operation, the presence-based security system 300 can monitor the protected space using a network of smart devices 316. When an event is detected, such as the arrival of an unknown wireless device or unusual motion patterns, the computer system 312 processes the incoming data and classifies the event. Based on the classification and threat assessment, the presence-based security system 300 may take automated actions such as locking doors, activating lights, or sounding alarms using the connected smart devices 316. Simultaneously, the presence-based security system 300 can send notifications to the user's mobile device 304, providing real-time information about the detected event and enabling the user to take manual control if desired. For events classified as potential security threats, the presence-based security system 300 may also alert the alarm and video monitoring service 320 using the security service provider 308, enabling rapid professional response.

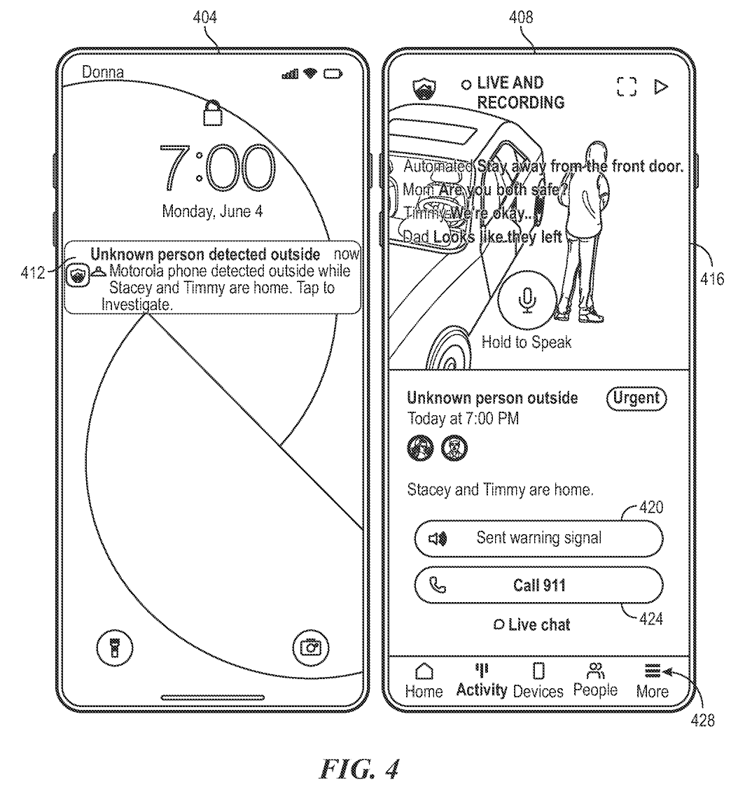

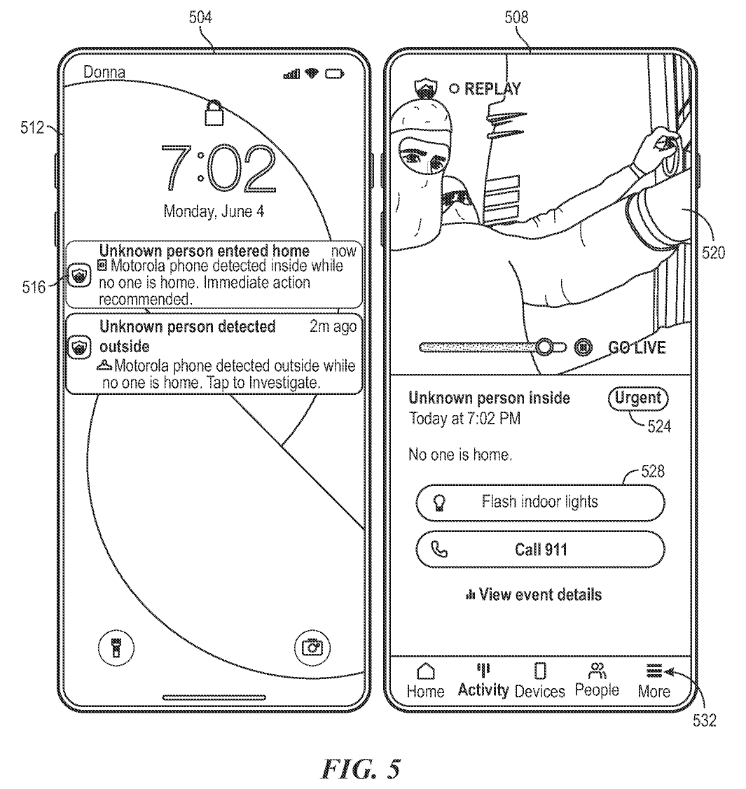

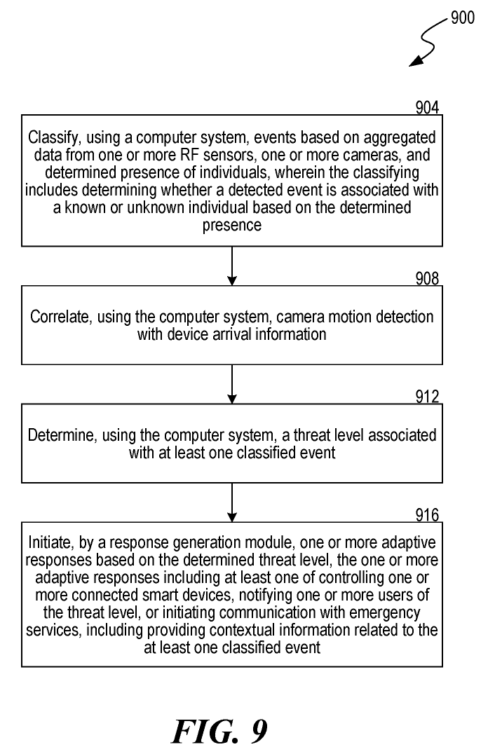

The computer system 312 can generate a response based on the determined presence and the classified events using a response management module. An alert generation module may send an alert to a mobile device of an authorized user, as shown in FIGS. 4 and 5 , where the user interfaces display notifications of detected events. An emergency services interface module may initiate communication with emergency services, as depicted in FIG. 1. Additionally, the system may notify a central monitoring station, represented by an alarm and video monitoring service in FIG. 3. The response generation process, outlined in FIGS. 9 and 10 , involves initiating adaptive responses based on the determined threat level. These responses may include controlling connected smart devices, notifying users of a threat level via a mobile device, or initiating communication with emergency services, while providing contextual information related to the classified event, as detailed in step 916 of FIG. 9.

The distributed architecture of the presence-based security system 300 provides redundancy and fault tolerance. If the local computer system 312 experiences issues, critical functions can be temporarily offloaded to the security service provider 308, providing uninterrupted protection. Similarly, if internet connectivity is lost, the local components can continue to operate independently, maintaining basic security functions. The system's ability to learn and adapt over time is enabled by this architecture. Usage patterns, device behaviors, and event outcomes can be analyzed by the security service provider 308 to refine the system's detection and classification algorithms. This learning can be shared across multiple systems, enabling users to benefit from collective security intelligence while maintaining individual privacy.

FIG. 4 illustrates example mobile device interfaces displaying security system notifications and controls, according to aspects of the present disclosure. A mobile device 404 displays a mobile device interface 408 that provides real-time security information and interactive response options. FIG. 4 shows an example notification 412 alerting the user to an unknown person detected outside, while also indicating that authorized or known individuals are present within the monitored space. FIG. 4 also illustrates the disclosed systems’ capability to integrate presence detection, video monitoring, and user communication functionalities into a mobile application interface.

The mobile device interface 408 can display a live video feed 416 at the top, enabling users to visually monitor the premises. Below the video, an example notification alerts the user to an "Unknown person detected outside" while also informing that "Stacey and Timmy are home." The interface provides interactive options including a "Send warning signal" button 420 and a "Call 911" button 424 for immediate response actions. At the bottom, example navigation controls 428 offer access to different sections of the application such as Home, Activity, Devices, People, and More. The mobile device 404 enables users to receive real-time notifications and interact with the security infrastructure remotely.

The navigation controls 428 provide access to different sections of the application. The "Home" section can provide an overview of the system's status. The "Activity" section may offer a log of recent events and detections, leveraging the event classification capabilities of the system. The "Devices" section can enable users to manage and control connected smart devices. The "People" section illustrates the ability to track and manage known individuals and their associated devices. The "More" section may offer additional settings and features.

FIG. 5 illustrates example mobile device interfaces displaying security system notifications, according to aspects of the present disclosure. An example mobile device interface 508 displays different aspects of the security system's functionality. The mobile device 504 displays an example lock screen 512 with time, date, and urgent notifications 516 about detected unknown persons. The mobile device interface 508 shows a more detailed alert screen with a video feed 520, specific alert information 524, and action buttons 528 for user response. The mobile device interface 508 can include options for flashing indoor lights and calling emergency services, as well as navigation controls for accessing various sections of the security application.

The mobile device 504 can display a lock screen notification 516, providing alerts even when the device is locked. This feature enables users to be promptly informed of potential security threats. The example notification 516 shown by FIG. 5 indicates "Unknown person entered home" at 7:02 on Monday, June 4, followed by another alert stating "Unknown person detected outside." This dual notification illustrates the capability to detect and differentiate between multiple security events simultaneously, as enabled by multiple sensors and/or receivers and cameras.

The mobile device interface 508 presents a more detailed alert screen, which is accessed by interacting with the lock screen notification. At the top of this screen is a video feed 520. The integration of live video directly into the example mobile device interface 508 enables users to visually verify and assess any detected security events, enhancing the system's effectiveness and user engagement. Below the video feed, the example mobile device interface 508 displays an "Unknown person inside" alert 524, marked as "Urgent" and timestamped "Today at 7:00 PM." This alert 524 demonstrates event classification capabilities. The presence-based security system, utilizing its array of sensors and/or receivers and cameras, has detected that an unauthorized/unknown person is present within or around the monitored space.

The alert 524 also indicates that "No one is home," which illustrates the system's presence determination capabilities. For example, the system has scanned for known wireless devices associated with authorized users and, finding none present, has concluded that the detected person is unauthorized. The example mobile device interface 508 provides two action buttons 528: "Flash indoor lights" and "Call 911" (generating a response based on a classified event). The "Flash indoor lights" button enables users to activate connected smart devices as a deterrent measure.

At the bottom of the example mobile device interface 508, example navigation controls 532 provide access to different sections of the application: Home, Activity, Devices, People, and More. These sections correspond to various functionalities of the presence-based security system. For example, the "Home" section provides an overview of the system's current status. The "Activity" section may offer a log of recent events and detections, leveraging the event classification capabilities of the system. The "Devices" section enables users to manage and control connected smart devices. The "People" section relates to the system's ability to track and manage known individuals and their associated devices.

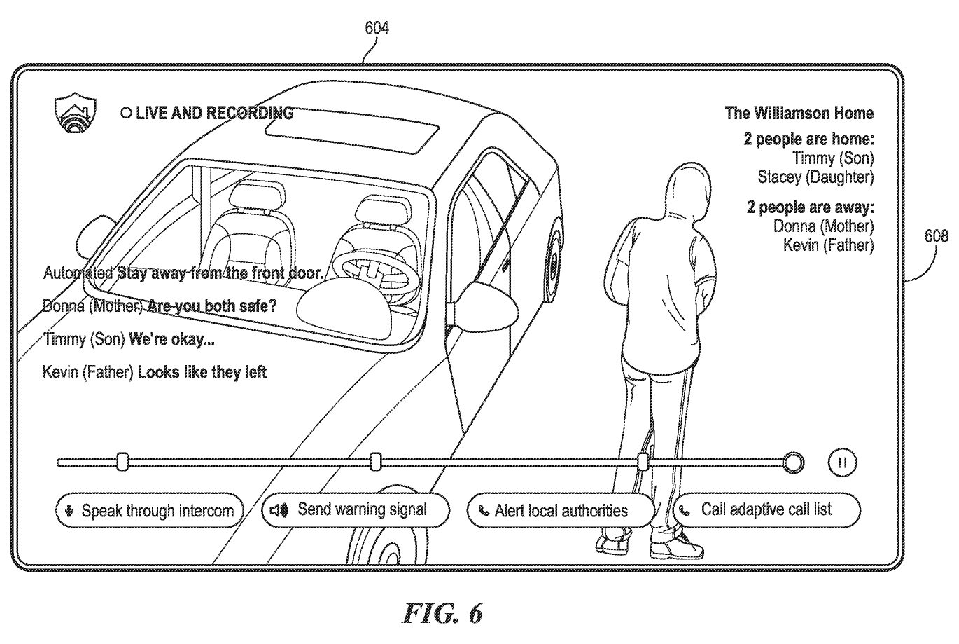

FIG. 6 shows an example video monitoring interface 604 for a security system, according to aspects of the present disclosure. The video monitoring interface 604 depicted in FIG. 6 presents a view of the security system's video surveillance capabilities. The interface 604 displays a central video feed 608 sourced from one of the system's cameras. Surrounding the video feed 608 are various status indicators and control elements, enabling users to interact with the security system and respond to detected events.

The video feed 608 displayed in the example video monitoring interface 604 can be processed by a video processing module. This module may apply various image enhancement techniques to improve visibility, especially in low-light conditions. Additionally, the video processing module may incorporate motion detection algorithms and object recognition capabilities, aligning with the system's ability to classify events and identify known and unknown individuals. Surrounding the central video display are various status indicators and control elements. These elements can include information about the current system status, such as whether the security system is armed or disarmed, and indicators for detected motion or presence. Users can use this information to quickly assess the security situation at a glance.

The video monitoring interface 604 can include options for users to save, export, or share video clips. The video monitoring interface 604 may also incorporate AI and machine learning capabilities to enhance its functionality over time. For example, the system learns to recognize regular visitors or distinguish between routine activities and potential security threats based on accumulated video data. This adaptive learning capability improves the accuracy of event classification and reduce false alarms. The example video monitoring interface 604 can include options for multi-camera views, enabling users to monitor multiple areas of their property simultaneously.

In some implementations, the video monitoring interface 604 is used to define perimeters of the monitored space during system installation and setup, for example, by providing interactive configuration tools that integrate with underlying wireless sensing capabilities and camera positioning data. For example, the video feed 608 displays real-time visual information from cameras positioned to capture comprehensive coverage of the monitored area. Detection boundaries can be established using signal strength measurements correlated with visual landmarks shown in the video feed 608, enabling precise perimeter definition with example RSSI thresholds ranging from -30 decibel-milliwatts (dBm) for immediate proximity within 2 meters to -90 dBm for maximum detection range extending approximately 50 m from sensor locations.

The video monitoring interface 604 can provide users with a graphical three-dimensional visualization of the protective perimeter envelope, for example, by rendering wireless coverage zones as overlaid graphics on the live video feed 608. This visualization can incorporate maximum detection ranges and enables configuration of user-defined exclusion zones, such as public areas or neighboring properties that should be ignored during security monitoring operations. Users can interact with the three-dimensional representation displayed on the video monitoring interface 604 to modify coverage parameters and/or establish custom monitoring zones tailored to specific security requirements.

The video monitoring interface 604 can also enable users to define specific perimeter areas based on wireless signal strength thresholds using intuitive graphical controls integrated with the video feed 608 display. For example, detection zones can be customized with configurable RSSI boundaries, such as -50 dBm for high-security areas within 2 m of critical entry points, -65 dBm for moderate monitoring zones extending to 5 m, and -75 dBm for general presence detection covering areas up to 15 m from sensor positions.

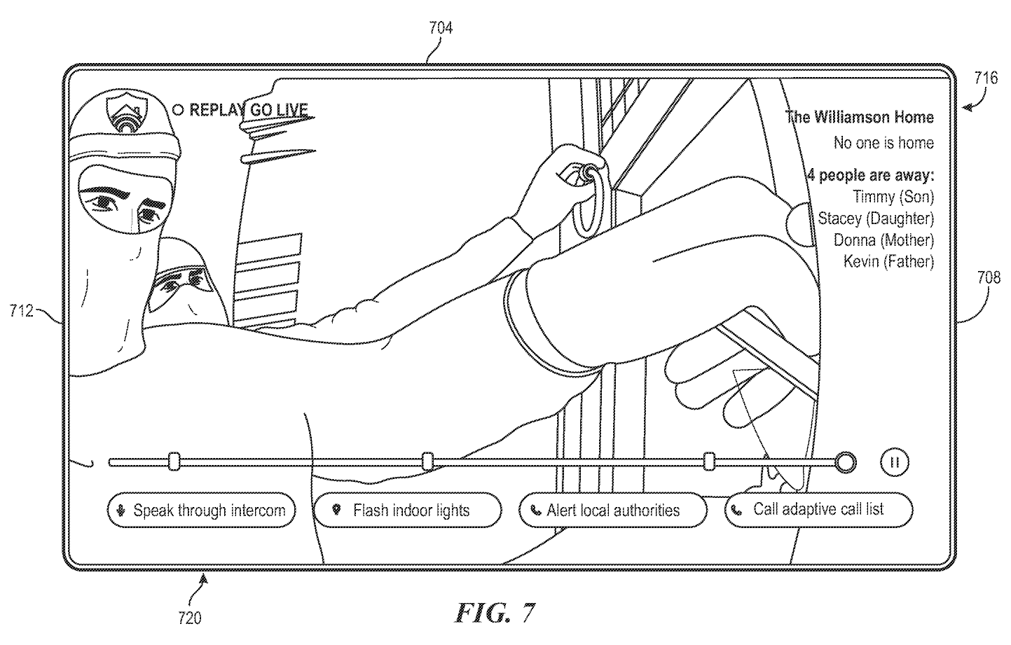

FIG. 7 is a drawing that illustrates an example video monitoring interface 704 for a security system, according to aspects of the present disclosure. The video monitoring interface 704 can be used by a presence-based security system (e.g., system 100 shown by FIG. 1) that uses video data and wireless sensing. The example video monitoring interface 704 exemplifies the security system’s capability to provide real-time visual monitoring and interactive control options.

The video monitoring interface 704 depicted in FIG. 7 presents a view of the security system's video surveillance capabilities. The video monitoring interface 704 displays a central video feed 708 showing a silhouette of a person 712, captured by one of the security system’s cameras. Surrounding the video feed 708 are various status indicators and control elements, enabling users to interact with the security system and respond to detected events. The video monitoring interface 704 provides the video content while providing easy access to essential monitoring and control functions, demonstrating user-friendly security management. The video monitoring interface 704 displays elements 716 such as "The Williamson Home" at the top, indicating the monitored space, and various interactive options and status indicators arranged around the edges of the screen.

FIG. 7 also displays a silhouette of an individual 712, suggesting that the security system has detected and is tracking movement within and around the monitored space. The cameras providing the video feed 708 can operate in conjunction with sensors and/or receivers to provide a multi-layered approach to presence detection and event classification. In some implementations, the security system can capture high-quality video even in low-light conditions for more effective nighttime surveillance than traditional security systems. The video monitoring interface 704 displays "The Williamson Home," indicating a specific location being monitored. Such personalization features enable users to identify the property or area they are viewing, which is particularly useful for systems monitoring multiple locations.

The video feed 708 can be processed by a video processing module, as described in more detail with reference to FIG. 2. This module can apply various image enhancement techniques to improve visibility, especially in low-light conditions. Additionally, the video processing module may incorporate motion detection algorithms and object recognition capabilities, improving the system's ability to classify events and identify known and unknown individuals. The video monitoring interface 704 can also include options 720 for two-way audio communication when the cameras are equipped with speakers and microphones. The system can thus generate responses, such as sending warning signals or communicating with individuals on the premises. In a scenario like the one depicted, where an unknown person is detected, the user might use this feature to issue a verbal warning or inquiry.

The video monitoring interface 704 is designed to be accessible locally and/or remotely, enabling users to view live video feeds and recorded footage from their mobile devices or computers. Users can be provided with real-time information and control, regardless of their location. In a situation like the one shown, where a potential intruder is detected, the ability to access this interface remotely is useful for the property owner to assess the situation and take appropriate action. The video monitoring interface 704 can incorporate features such as motion-activated recording and alert generation. When the system detects motion or an unidentified presence, it can automatically highlight the relevant video segment and generate an alert for the user.

The video monitoring interface 704 can provide options for users to save, export, or share video clips. This feature can be useful for providing evidence to law enforcement in the event of a security incident, aligning with the system's capability to interface with emergency services. When there is evidence of a potential intruder, the ability to quickly save and share this video can be useful for any subsequent investigation. The video monitoring interface 704 may also incorporate AI and machine learning capabilities to enhance its functionality over time, e.g., using the example AI system 1500 illustrated and describe in more detail with reference to FIG. 15. For example, the security system can learn to recognize regular visitors or distinguish between routine activities and potential security threats based on accumulated video data. This adaptive learning capability can improve the accuracy of event classification and reduce false alarms.

Privacy considerations can be built into the video monitoring interface 704, enabling users to define privacy zones or schedule recording times to respect the privacy of occupants and neighbors. The video monitoring interface 704 can include options for multi-camera views, enabling users to monitor multiple areas of their property simultaneously. The video monitoring interface 704 can integrate with other smart home systems. For example, temperature data from smart thermostats or status information from connected smoke detectors can be displayed, providing a more comprehensive overview of the property's status beyond security. The video monitoring interface 704 can include user authentication measures such that only authorized individuals can access the live video feeds and recorded footage. For example, biometric authentication, two-factor authentication, or other advanced security protocols to protect sensitive video data can be used.

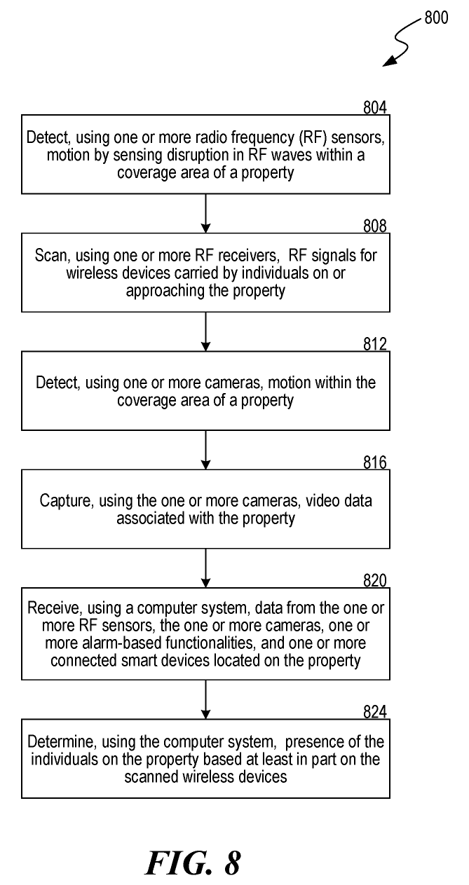

FIG. 8 is a flowchart illustrating an example process 800 for presence detection using wireless sensing and video, according to aspects of the present disclosure. In some implementations, the process 800 is performed by the system 100 illustrated and described in more detail with reference to FIG. 1. In some implementations, the process 800 is performed by a computer system, e.g., example computer system 1600 illustrated and described in more detail with reference to FIG. 16. Particular entities, for example, AI system 1500, perform some or all of the steps of the process 800 in other implementations. The AI system 1500 is illustrated and described in more detail with reference to FIG. 15. Likewise, implementations can include different and/or additional steps or can perform the steps in different orders.

At 804, a computer system uses one or more sensors to detect motion within and around a coverage area of a property. The coverage area can specify particular rooms within a property, portions of the outside of a building, or an entire property as well as exclude certain portions of a property. The detection is performed by the sensors sensing perturbations in the wireless signals present in the environment. The sensors scan for wireless signals at a location. When an object or individual moves within the coverage area, it causes changes or perturbations in the characteristics of the signals. The sensors are configured to detect and measure these disturbances in the field.

The detection of motion using the sensors is performed by leveraging the principle that human bodies, being composed largely of water, perturb wireless signals. The sensors, which may include components such as antennas, RF and electrical hardware, and signal processing software, continuously, intermittently, or periodically emit and receive wireless signals within the property's coverage area. The wireless signals can be in frequency ranges, for example, 400 Megahertz (MHz) to 6 Gigahertz (GHz), encompassing common wireless protocols. When a person moves through the monitored space, their body absorbs and reflects the signals, causing measurable changes in signal strength, phase, or time-of-flight.

For example, human bodies can absorb and scatter signals in the 2.4 GHz, 5 GHz, and 6 GHz frequency bands. When individuals move through monitored spaces, they cause measurable changes in signal amplitude, phase shifts, and multipath reflections. Bodies may block direct signal paths, create shadow zones, and generate Doppler frequency shifts during movement. Signal processing algorithms can be used to analyze the perturbations in real-time, filtering out ambient noise and static objects to isolate and identify patterns indicative of human movement. The computer system can detect motion even through walls or in low-light conditions, providing a complementary layer of security alongside traditional motion sensing technologies. By identifying these perturbations, the computer system or the sensors can ascertain that motion has occurred within a sensing range.

At 808, the computer system uses one or more wireless receivers to scan wireless signals to detect wireless devices carried by individuals on or approaching the property. The wireless receivers, which may be part of the sensors 104 shown in FIG. 1, are configured to detect various wireless signals such as Wi-Fi, Bluetooth, and cellular transmissions. The receivers monitor the electromagnetic spectrum within the property's vicinity, focusing on frequency bands commonly used by personal electronic devices. Signal processing algorithms can be used to analyze the received signals, identifying unique identifiers such as media access control (MAC) addresses or device signatures. The computer system can detect and potentially identify specific mobile devices that are present, even if they are not connected to the property's wireless network. The data collected from this scanning process is then transmitted to the computer system, where it is aggregated with other sensor data to determine the presence and identity of individuals on or near the property.

At 812, the computer system uses one or more cameras to detect motion within and around the coverage area of the property. For example, the detection of motion can be performed by the deployment of at least one camera as shown in FIG. 1. The cameras can be positioned to capture video data associated with the property. The cameras or the computer system can include processors that use motion detection algorithms that analyze sequential video frames to identify changes indicative of movement. The algorithms can include background subtraction, optical flow analysis, or machine learning-based object detection. The cameras can be equipped with infrared capabilities for low-light conditions. A video processing module within the computer system can process the incoming video streams in real-time, applying filters and noise reduction techniques to reduce false positives. When motion is detected, the computer system can trigger alerts, initiate recording, or activate other connected devices. The visual motion detection complements the RF-based sensing, providing a multi-layered approach to presence detection within and around the property.

At 816, the computer system captures video data associated with the property using one or more cameras depicted in FIG. 1. The cameras can periodically or continuously capture high-definition video streams, which may include both visible light and infrared spectra for day and night operation. The video data can be digitized and/or compressed using advanced codecs to reduce storage and improve transmission efficiency. The captured video can be transmitted to the computer system, where it is processed by a data aggregation module and a video processing module. The video data can serve multiple purposes within the security system, including real-time monitoring, event verification, and/or forensic analysis. The video capture provides visual evidence for any detected events, supporting the computer system's ability to classify and respond to various security scenarios.

At 820, the computer system receives data from multiple sources integrated within the presence-based security system. The wireless receivers provide wireless signal data, including Wi-Fi probe requests, Bluetooth signals, and/or cellular transmissions, which contain information about detected devices and their signal characteristics. The cameras supply video data, capturing visual information about the property's surroundings. Alarm-based functionalities, such as smoke detectors or carbon monoxide sensors, can contribute alert signals when triggered. Connected smart devices or other Internet of Things (IoT) devices can transmit status updates and sensor readings. The computer system, which may be implemented as a local processing unit or a cloud-based server, can aggregate this diverse data stream using a data aggregation module. This module harmonizes the inputs, preparing them for subsequent analysis by the system's intelligence module.

At 824, the computer system determines that individuals are present on the property by analyzing the aggregated data, e.g., using the identified wireless devices present. For example, the computer system can include a presence determination module that processes the wireless receiver data, identifying unique device signatures. This information can be correlated with historical data to recognize known devices associated with authorized users. The computer system can use machine learning algorithms to classify detected devices and infer occupancy status. Video data from cameras can be analyzed to corroborate wireless -based presence detection, while input from alarm functionalities and smart devices can provide additional context. The computer system can synthesize the different data points to create a more comprehensive presence profile than traditional security systems, distinguishing between known occupants, guests, and potential security threats.

FIG. 9 is a flowchart illustrating an example process 900 for event classification and response generation, according to aspects of the present disclosure. In some implementations, the process 900 is performed by the system 100 illustrated and described in more detail with reference to FIG. 1. In some implementations, the process 900 is performed by a computer system, e.g., example computer system 1600 illustrated and described in more detail with reference to FIG. 16. Particular entities, for example, AI system 1500, perform some or all of the steps of the process 900 in other implementations. The AI system 1500 is illustrated and described in more detail with reference to FIG. 15. Likewise, implementations can include different and/or additional steps or can perform the steps in different orders.

At 904, a computer system classifies events based on aggregated data from multiple sources. For example, an event can include one or more individuals or objects approaching a property or an individual that is already on the property and is moving. The computer system can use input from sensors and/or receivers, which can detect wireless signals and perturbations in wireless signals, cameras that capture video data, and previously determined presence information. An event classification module can process this aggregated data to categorize detected events. The computer system can use machine learning algorithms, such as gradient-boosting decision trees, to analyze patterns and correlations in the data. During classification, the computer system can determine whether a detected event is associated with a known or an unknown individual by comparing detected wireless device signatures to a database of known devices linked to authorized users. The computer system can differentiate between expected activities of known individuals and potential security threats from unknown entities, enhancing the accuracy and context-awareness of the security assessment.

At 908, the computer system correlates camera motion detection with device arrival information. A correlation and sensor fusion module integrates data from the cameras' motion detection capabilities with the wireless receivers’ device detection functionality. When motion is detected by a camera, the computer system can cross-reference this information with contemporaneous wireless device detections from the receivers. The computer system can analyze the timing and location of both the motion detection and device arrival to establish a relationship between physical movement and that wireless devices are present. The correlation helps distinguish between motion caused by known individuals carrying recognized devices and potential security threats from unknown entities. The computer system can use statistical analysis techniques to quantify the strength of correlation between motion events and device detections, further refining its ability to accurately classify events and identify anomalies.

At 912, the computer system determines a threat level associated with at least one classified event. A threat level assessment module analyzes the classified event data in conjunction with the correlated motion and device information. The computer system can use a multi-factor risk assessment algorithm that considers various parameters such as the event type, time of occurrence, presence of known or unknown individuals, and historical patterns. The threat level may be categorized on a scale, for example, from low to high urgency. The computer system can use machine learning models trained on historical event data to predict potential outcomes and assign appropriate threat levels. Factors such as the number of unknown devices detected, the location of the event within the property, and the correlation strength between motion and device arrival can contribute to the threat level determination. This analysis enables the computer system to prioritize events and allocate resources more effectively than traditional security systems.

At 916, the computer system initiates one or more adaptive responses based on the determined threat level. A response generation module can use a decision matrix that maps threat levels to appropriate actions. For lower threat levels, the computer system may control connected smart devices, such as automatically locking smart locks or activating connected light bulbs to deter potential intruders. For moderate threat levels, the computer system may notify users using a mobile application, providing real-time alerts with contextual information about the classified event. In high-threat scenarios, the computer system may initiate communication with emergency services, transmitting relevant data including video feeds, device information, and event classification details. The adaptive responses are designed to escalate proportionally to the threat level, providing an appropriate and measured reaction to each security event. The computer system can learn from user feedback and event outcomes to refine its response strategies over time.

The computer system can detect an unknown wireless device approaching the location using sensors and/or receivers, which scan for wireless signals. A device identification module can analyze the detected signals to determine if they match known device signatures stored in the system. Upon detecting an unknown device, an arrival detection module flags this as a potential security event. An event classification module categorizes this as an unknown arrival. Based on this classification, a threat level assessment module may determine an elevated risk level. In response, a device control module can automatically engage smart locks to secure entry points. Simultaneously, the system can activate connected light bulbs using smart lights control functionality. This coordinated response can autonomously react to potential security threats by integrating wireless sensing, event classification, and automated device control.

FIG. 10 is a flowchart illustrating an example process 1000 for presence detection and response generation, according to aspects of the present disclosure. In some implementations, the process 1000 is performed by the system 100 illustrated and described in more detail with reference to FIG. 1. In some implementations, the process 1000 is performed by a computer system, e.g., example computer system 1600 illustrated and described in more detail with reference to FIG. 16. Particular entities, for example, AI system 1500, perform some or all of the steps of the process 1000 in other implementations. The AI system 1500 is illustrated and described in more detail with reference to FIG. 15. Likewise, implementations can include different and/or additional steps or can perform the steps in different orders.

At 1004, the computer system uses sensors and/or receivers to scan for wireless signals at a location. The receivers scan the electromagnetic spectrum within their coverage area, capturing probe requests, beacon frames, and other wireless transmissions. The computer system can use specialized hardware and software to process the captured wireless data. The scanning process enables the computer system to create a wireless environment map of the location, detecting both active transmissions from devices and passive emissions from various electronic components. The collected wireless signal data serves as a foundation for subsequent presence detection and security analysis processes.

At 1008, the computer system uses at least one camera to capture video at the location. The cameras can be high-definition security cameras with capabilities such as motion detection, night vision, and/or two-way audio communication. The video capture process can include continuous recording or event-triggered recording based on detected motion or other sensor inputs. The captured video data can be compressed and transmitted to the computer system for processing and analysis. The video monitoring interface 604 shown in FIG. 6 illustrates how the computer system can present captured video data to users or monitoring personnel. The integration of video data with wireless sensing enhances the system's ability to verify and classify detected events accurately.

At 1012, the computer system detects one or more wireless devices based on the wireless signals captured by the wireless receivers. This detection process involves analyzing the characteristics of the received wireless signals, including signal strength, frequency, and embedded device identifiers. A device identification module can process this data. The computer system can use machine learning algorithms, as described with reference to the AI model 1530 of FIG. 15, to classify and identify different types of wireless devices. This detection capability enables the computer system to distinguish between known devices associated with authorized users and unknown or potentially suspicious devices. The process of detecting wireless devices is used for determining occupancy and identifying potential security threats.

At 1016, the computer system detects motion at the location based on perturbations in the wireless signals. The sensors are used to sense disturbances in the ambient wireless environment caused by moving objects or individuals. The computer system can analyze variations in signal strength, phase shifts, and other wireless characteristics to infer motion. The disclosed methods complement motion detection techniques used by cameras, providing an additional layer of sensing that can operate in low-light conditions or areas not covered by video surveillance. A motion analysis module can process the RF-based motion data. By correlating RF-based motion detection with other sensor inputs, the computer system can distinguish between different types of movement and reduce false alarms more accurately than traditional security systems, enhancing the overall reliability of the security system.

The computer system can use a video processing module to analyze the video data captured by a camera to detect motion within and around the monitored space. The module can work in conjunction with a motion analysis module, which processes data from multiple sources. The computer system can use image processing techniques, potentially leveraging an AI model to identify changes between video frames that indicate movement. This video-based motion detection complements the RF-based motion sensing, enhancing the system's overall ability to accurately detect and classify events within and around the monitored space.

At 1020, the computer system determines that at least one known or unknown individual is present at the location based on the detected wireless devices, the detected motion, or the video data. The determination process can include a multi-faceted approach combining data from various sources. A presence determination module can analyze patterns in wireless device detections, correlating them with known user profiles stored in the system. Simultaneously, the motion detected using wireless signal perturbations is evaluated in conjunction with video analysis to confirm physical presence. The computer system can use AI techniques, such as those described with reference to the AI system 1500 of FIG. 15, to process this diverse data and make accurate presence determinations. This approach enables the computer system to distinguish between authorized occupants, guests, and potential intruders, providing a more nuanced understanding of the security situation at the location compared to conventional systems.

The computer system can use sensors to detect alarm signals from a smoke detector or a carbon monoxide detector. These signals can be received by a data aggregation module and processed alongside other sensor inputs. A correlation and sensor fusion module can integrate this data with presence information and video data, enabling an event classification module to contextualize potential security threats with environmental hazards. The disclosed approaches enable the computer system to distinguish between different types of emergencies, enhancing the accuracy of threat assessment and response generation.

The computer system can use an event classification module to classify events at the location based on the determined presence and video data. The module can analyze aggregated inputs from a presence determination module and video processing module to categorize detected events. Machine learning algorithms, such as those implemented in the AI model 1530, can be used to recognize patterns and correlate presence information with visual data. The classification process enables the system to distinguish between normal activities and potential security threats, considering factors like known versus unknown individuals and their behaviors captured on video.

The computer system, using an event classification module, can refine event classification by incorporating alarm signals from alarm-based functionalities, which may include smoke detectors or carbon monoxide detectors. As illustrated in FIG. 1, these alarm signals can be received by a data aggregation module and processed alongside sensor and camera data. A correlation and sensor fusion module integrates these diverse inputs, enabling an event classification module to contextualize potential security threats with environmental hazards. The disclosed methods enable the computer system to distinguish between different types of emergencies, such as differentiating a break-in from a fire or gas leak, thereby enhancing the accuracy and specificity of the threat assessment and response generation.

At 1024, the computer system generates a response based on determining that at least one known or unknown individual is present. A response management module can be used to perform this process. Depending on the nature of the detected presence, the computer system can perform various actions. For known individuals, the computer system can log their presence or adjust smart home settings. For unknown individuals, especially in unexpected scenarios, the computer system can trigger more active responses. The responses can include sending alerts to the user's mobile device (see FIGS. 4-5), activating connected smart devices like lights or locks, or in high-threat situations, automatically contacting emergency services. The adaptive nature of the responses, tailored to the specific context of the detected presence, significantly enhances the effectiveness of the security system compared to conventional systems.

The computer system can use a device control module to control a smart device based on the classified event determined by the event classification module. As illustrated in FIG. 1, the computer system is communicatively coupled to these smart devices. Upon classifying an event, the computer system can activate smart lights to deter potential intruders or engage the smart locks to secure the property. This adaptive response, as shown in FIG. 9 (step 916), enhances the security system's ability to react autonomously to detected threats.

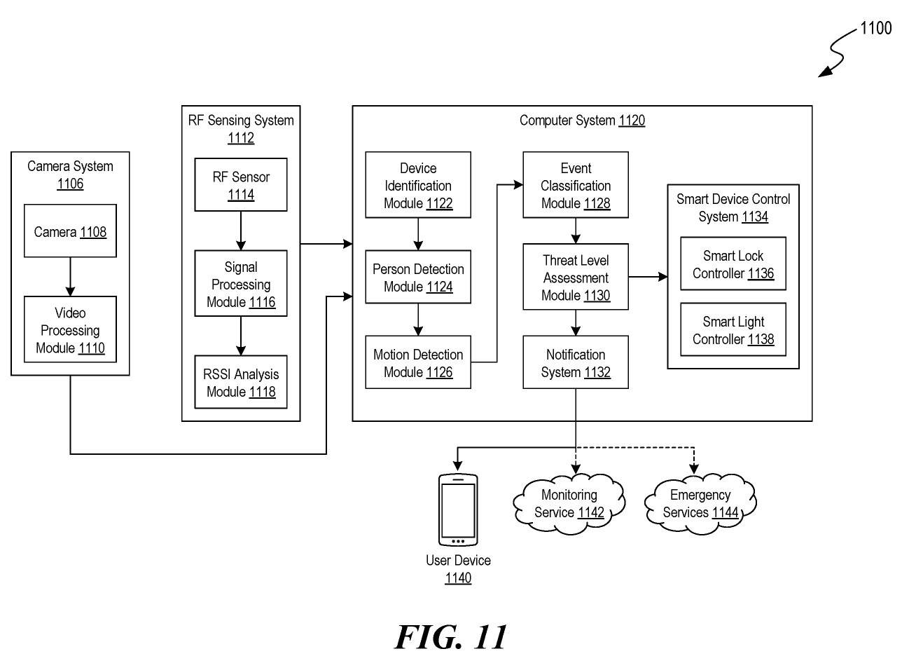

FIG. 11 is a block diagram that illustrates an example presence-based security system 1100 that can implement aspects of the present technology. As shown, the presence-based security system 1100 includes a camera system 1106, an RF sensing system 1112, and a computer system 1120. The presence-based security system 1100 can further include a user device 1140, a monitoring service 1142, and emergency services 1144. In some cases, the presence-based security system 1100 implements wireless sensing using wireless signals that are not in the RF-spectrum, e.g., acoustic signals, Infrared signals, VLC signals, FSO signals, UV signals, NFC signals, or a combination thereof as described in more detail with reference to FIG. 1.

The camera system 1106 provides visual monitoring capabilities for the presence-based security system 1100. The camera system 1106 includes a camera 1108 and a video processing module 1110. The camera 1108 may incorporate advanced features such as night vision, wide-angle lenses, or pan-tilt-zoom capabilities to provide visual coverage of a monitored area. The camera 1108 may use high-resolution image sensors and sophisticated image processing algorithms to enhance the quality and usefulness of captured video data. The video processing module 1110 applies various image enhancement techniques to improve visibility, especially in low-light conditions. Additionally, the video processing module 1110 may incorporate motion detection algorithms and object recognition capabilities using computer vision techniques. The video processing module 1110 may use AI and machine learning capabilities to learn to recognize regular visitors or distinguish between routine activities and potential security threats based on accumulated video data.

In some implementations, the computer system 1120 defines perimeters of the monitored space during system installation and setup, for example, by executing calibration routines using data from the RF sensing system 1112 and camera system 1106. The RF sensors 1114 and signal processing module 1116 can establish detection boundaries by measuring wireless signal coverage across frequency ranges encompassing different wireless protocols. The RSSI analysis module 1118 can process signal strength measurements to map different coverage areas. The device identification module 1122 can correlate these measurements with spatial coordinates to create comprehensive perimeter definitions.

The notification system 1132 can provide users with a graphical three-dimensional visualization of the protective perimeter envelope on the user device 1140, rendering the maximum detection ranges and enabling configuration of user-defined exclusion zones. For example, the computer system 1120 processes video data from the camera 1108 and video processing module 1110 to overlay visual boundaries onto the spatial representation, incorporating both wireless coverage areas and camera field-of-view parameters. This visualization can display detection sensitivity gradients across different zones, for example, with indoor boundaries 10-15 dBm higher than outdoor settings due to environmental factors. The system 1120 can also enable users to define specific perimeter areas based on wireless signal strength thresholds using the smart device control system 1134 interface. The event classification module 1128 can process user-defined parameters to create adaptive monitoring zones, while the threat level assessment module 1130 applies different security protocols based on perimeter segment classifications, enabling tailored responses for various areas within the monitored space.

The RF sensing system 1112 detects and analyzes wireless signals within and around the monitored environment. The RF sensing system 1112 includes RF sensors 1114, a signal processing module 1116, and an RSSI analysis module 1118. The RF sensing system 1112 may include wireless receivers in addition to RF sensors 1114, where wireless receivers are used to receive and decode wireless signals, enabling communication and data transfer. One or more RF sensors 1114 and one or more wireless receivers can be part of the same hardware module and/or a wireless sensor can be included within the hardware of a wireless receiver.

The RF sensors 1114 may use thermal sensors which measure wireless power by sensing temperature increases in thermally conductive materials heated by wireless signals. The RF sensors 1114 may use diode sensors. The RF sensors 1114 may use calibrated sensors which combine thermal or diode methods with additional circuitry designed to measure wireless signal power over specific frequency ranges. The RF sensors 1114 may use RF-EMF sensors which measure the strength of electromagnetic fields in specific frequency bands. The signal processing module 1116 processes the raw wireless data collected by the RF sensors 1114, applying algorithms to extract meaningful information from the wireless signals.

The RSSI analysis module 1118 analyzes received signal strength indicator values to determine spatial and temporal characteristics of detected wireless devices. The RSSI analysis module 1118 may determine linger time of individuals located within a threshold distance from the camera 1108 based on duration of detected wireless signals above a threshold RSSI value. The RSSI analysis module 1118 may analyze trends in RSSI values over a predetermined time window, e.g., between 10 seconds and 5 minutes. The RSSI analysis module 1118 may determine whether a wireless device is approaching or leaving by using a moving average of RSSI values over a sliding time window comprising measurements taken over a period, e.g., 30 seconds to 2 minutes.

The computer system 1120 combines data from multiple sources to determine occupancy and identify individuals within and around the monitored space. The computer system 1120 includes a device identification module 1122, a person detection module 1124, and a motion detection module 1126. The computer system 1120 may provide both whole-home presence detection using sensors positioned throughout a location and localized presence detection for individuals located within a threshold distance from cameras. The device identification module 1122 analyzes detected signals by comparing them against a database of known device signatures, including MAC addresses, manufacturer information, and connection capabilities from Wi-Fi probe requests, cellular signals, or Bluetooth signals. The device identification module 1122 may use Identity Resolving Keys (IRKs) to resolve Bluetooth advertisements from devices near the camera 1108.

The person detection module 1124 processes visual data from the camera system 1106 to identify and count individuals within the monitored area. The person detection module 1124 may work in conjunction with the device identification module 1122 to correlate detected persons with identified wireless devices. The motion detection module 1126 analyzes movement patterns using both signal perturbations and video data. The motion detection module 1126 may use probabilistic models and pattern recognition algorithms to identify and distinguish between different types of presences and arrivals. The motion detection module 1126 may use machine learning algorithms to improve accuracy over time, learning to distinguish between regular visitors and new arrivals.

The event classification module 1128 categorizes detected activities and occurrences based on aggregated sensor data. The event classification module 1128 receives inputs from the computer system 1120 and processes this information to classify events occurring within and around the monitored space. The event classification module 1128 may use techniques such as Kalman filtering, Bayesian networks, or deep learning models to fuse data from multiple sensors. The event classification module 1128 may use a combination of rule-based systems and machine learning classifiers to categorize detected events, trained on extensive datasets of normal and anomalous activities.

The threat level assessment module 1130 evaluates classified events to determine potential security risks and assign appropriate threat levels. The threat level assessment module 1130 receives classified event data from the event classification module 1128 and analyzes this information in conjunction with contextual factors. The threat level assessment module 1130 may incorporate risk analysis models and decision-making algorithms to evaluate the severity of classified events and determine appropriate response levels. The threat level assessment module 1130 may consider factors such as the time of day, the identity of individuals present, historical patterns of behavior, the event's timing and location within a property, and the number and types of unknown devices detected. The threat level assessment module 1130 may assign higher threat levels when unknown wireless devices are approaching compared to leaving.

The notification system 1132 generates and distributes alerts based on threat assessments and event classifications. The notification system 1132 receives input from the threat level assessment module 1130 and generates appropriate notifications for various recipients. The notification system 1132 may send alerts through multiple channels such as mobile applications, text messages, or email. The notification system 1132 may provide users with live video streaming, instant alerts for detected events, and the ability to arm or disarm the system remotely through a dedicated smartphone application. The notification system 1132 may incorporate features such as push notifications and secure authentication mechanisms including biometric authentication or two-factor authentication.

The notification system 1132 communicates with the user device 1140, the monitoring service 1142, and emergency services 1144. The user device 1140 may be a smartphone, tablet, or other portable device capable of receiving notifications and providing user control interfaces. The monitoring service 1142 may be a professional security service that receives, analyzes, and responds to alerts from security systems, providing human oversight and coordination with emergency responders when necessary for detected events. The emergency services 1144 may be public safety organizations including police, fire departments, or medical services that respond to urgent situations and can be automatically contacted by the security system during high-threat events.

The smart device control system 1134 manages automated responses to security events through connected devices. The smart device control system 1134 includes a smart lock controller 1136 and a smart light controller 1138. The smart device control system 1134 may automatically lock smart locks when an unknown presence is detected or when unknown wireless devices are approaching and an event is classified as a potential security threat. The smart device control system 1134 may activate lights to deter potential intruders or adjust other home automation systems based on a security situation. The smart device control system 1134 may be connected through protocols such as Z-Wave, Zigbee, or Wi-Fi.

The smart lock controller 1136 manages the operation of electronic locking mechanisms based on security assessments. The smart lock controller 1136 may automatically engage locks when potential threats are detected or disengage locks when authorized individuals are identified. The smart light controller 1138 controls illumination devices for security purposes, such as activating deterrent lighting or providing enhanced visibility during security events.

The presence-based security system 1100 may include a speaker capable of producing clear and loud alerts or facilitating two-way communication in emergency situations. The presence-based security system 1100 may interface with external components through a network that uses advanced encryption and security protocols to provide the integrity and confidentiality of transmitted data. The presence-based security system 1100 network may support multiple communication technologies, including Wi-Fi, cellular, and potentially low-power wide-area network (LPWAN) protocols for extended range and reliability. The presence-based security system 1100 may incorporate alarm-based functionalities which include traditional security system components such as door sensors, window sensors, smoke detectors, or carbon monoxide detectors. The presence-based security system 1100 may be implemented using high-performance processors, ample memory, and specialized hardware accelerators to implement data processing and analysis tasks required for real-time security monitoring.

An emergency services interface may provide detailed information about the nature of a security event and the layout of a property when contacting emergency services 1144. The emergency services interface may be facilitated through integration with emergency response APIs or dedicated communication channels. The presence-based security system 1100 may leverage a cloud server that provides scalable computing resources and storage capabilities, enabling advanced analytics, long-term data retention, and potential integration with broader security networks.

In some implementations, the device identification module 1122 generates and maintains a comprehensive record of known and unknown wireless devices and their owners by processing wireless signals captured using the RF sensing system 1112. The device identification module 1122 analyzes detected signals received from the RF sensor 1114 and signal processing module 1116, extracting unique identifiers. The computer system 1120 correlates this device data with user profiles stored in a database, creating associations between specific individuals and their registered wireless devices. The RSSI analysis module 1118 can generate temporal data by tracking signal strength variations over time, enabling the system 1120 to maintain detailed timelines of when each wireless device was detected within the monitored space. The person detection module 1124 can further cross-reference visual data from the camera system 1106 with wireless device detections to verify presence correlations. The generated record enables the event classification module 1128 to distinguish between authorized occupants and potential security threats, while the notification system 1132 can provide users with historical presence data through the user device 1140 for review and analysis purposes.

The presence-based security system 1100 cloud infrastructure may employ containerization and microservices architectures to provide flexibility, scalability, and reliability in processing security-related data. The presence-based security system 1100 may provide redundancy and fault tolerance where if a local computer system experiences issues, functions can be temporarily offloaded to a cloud-based security service provider. The presence-based security system 1100 may continue to operate independently if internet connectivity is lost, maintaining basic security functions locally. The presence-based security system 1100 may learn and adapt over time by analyzing usage patterns, device behaviors, and event outcomes to refine detection and classification algorithms. The presence-based security system 1100 may share learning across multiple systems, enabling users to benefit from collective security intelligence while maintaining individual privacy. Privacy considerations may be built into a video monitoring interface, enabling users to define privacy zones or schedule recording times.

The presence-based security system 1100 may provide options for multi-camera views, enabling users to monitor multiple areas of their property simultaneously. The presence-based security system 1100 may integrate with other smart home systems, displaying temperature data from smart thermostats or status information from connected smoke detectors. The presence-based security system 1100 may detect not only that wireless devices are present but also other devices that emit signals such as tasers or drones on a property. The presence-based security system 1100 may be applied to elderly care and aging-in-place monitoring by tracking activities in a home and detecting anomalies. The presence-based security system 1100 may use data fusion techniques to combine information from disparate sources, normalizing and synchronizing data streams to create a coherent input for subsequent processing stages.

The presence-based security system 1100 may use machine learning algorithms such as gradient-boosting decision trees to analyze patterns and correlations in data for event classification. The presence-based security system 1100 may use statistical analysis techniques to quantify the strength of correlation between motion events and device detections. The presence-based security system 1100 may use a decision matrix that maps threat levels to appropriate actions for response generation. The presence-based security system 1100 may learn from user feedback and event outcomes to refine response strategies over time. The presence-based security system 1100 may suppress camera events when detected motion correlates with localized presence of a known wireless device. The presence-based security system 1100 may use linger time as a factor in determining whether to suppress or generate an alert for a camera event. The presence-based security system 1100 may measure RSSI values across multiple wireless protocols simultaneously.

The presence-based security system 1100 may use Infrastructure as a Service (IaaS) resources, which are computing resources offered by a cloud services provider. The presence-based security system 1100 may use software libraries including low-level primitives that form the foundation of low-level programming languages such as Intel Math Kernel Library, Nvidia cuDNN, Eigen, and Open BLAS. The presence-based security system 1100 may use machine learning frameworks such as TensorFlow, PyTorch, Scikit-Learn, Keras, Caffe, Random Forest, LightGBM, XGBoost, CatBoost, or Amazon Web Services Sage Maker. The presence-based security system 1100 may perform deep learning directly on input data to learn data representations using a cascade of multiple layers of nonlinear processing units for implicit feature extraction and transformation.

The presence-based security system 1100 may train algorithms using supervised learning, unsupervised learning, semi-supervised learning, and/or reinforcement learning. The presence-based security system 1100 may use classification techniques including boosting, decision tree learning, genetic programming, learning vector quantization, k-nearest neighbor (k-NN) algorithm, and statistical classification. The presence-based security system 1100 may use regression techniques including linear regression, multiple linear regression, logistic regression, regression tree analysis, least squares method, and gradient descent. The presence-based security system 1100 may use unsupervised learning techniques including clustering (density-based methods, hierarchical based methods, partitioning methods, grid-based methods), anomaly detection (Isolation Forest, local outlier factor, k-NN), and latent variable techniques (factor analysis, item response theory, latent profile analysis, latent class analysis). The presence-based security system 1100 may apply dimensionality reduction via linear discriminant analysis (LDA), PCA, independent component analysis, Isomap, kernel PCA, or other techniques to reduce the amount of data in feature vectors.

The presence-based security system 1100 may use model structures including decision trees, support vector machines, regression analyses, Bayesian networks, Gaussian processes, genetic algorithms, and artificial neural networks (Feedforward Neural Networks, CNNs, RNNs, Autoencoder, GANs). The presence-based security system 1100 may use loss functions including binary-cross entropy function, hinge loss function, regression loss function (mean square error, quadratic loss), mean absolute error function, smooth mean absolute error function, log-cosh loss function, and quantile loss function. The presence-based security system 1100 may use optimizers including Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The presence-based security system 1100 may apply regularization techniques including lasso (L1) regularization, ridge (L2) regularization, and elastic (L1 and L2 regularization) to prevent over- and under-fitting.

In operation, the presence-based security system 1100 may receive video captured by the camera 1108 and determine a number of persons depicted by the video using the video processing module 1110. The presence-based security system 1100 may receive wireless signals captured using the RF sensors 1114 and generate, using the wireless signals, presence information indicating that one or more wireless devices are present and one or more identifiers of the one or more wireless devices. The presence-based security system 1100 may detect perturbations in the wireless signals and detect, based on the perturbations, motion within a space. The presence-based security system 1100 may determine that at least one of a known person or an unknown wireless device is present by correlating the number of persons depicted by the video, the presence information, and the motion, wherein the known person is associated with at least one identifier. The presence-based security system 1100 may generate a notification indicating that at least one of the known person or the unknown wireless device is present and send the notification to the user device 1140.

The presence-based security system 1100 may determine, from the wireless signals, a received signal strength indicator (RSSI) using the RSSI analysis module 1118 and determine, using the RSSI, a location of the one or more wireless devices. The presence-based security system 1100 may determine a trend in RSSI values of the wireless signals and determine, using the trend, that a wireless device is approaching or leaving the space.

The presence-based security system 1100 may classify, based on correlating the number of persons depicted by the video, the presence information, and the motion, an event associated with the space using the event classification module 1128. The presence-based security system 1100 may determine a threat level for the event based on a location of the one or more wireless devices using the threat level assessment module 1130. The presence-based security system 1100 may generate a second notification indicating at least one of the unknown wireless device is present or the event and send, based on the threat level, the second notification to at least one of the monitoring service 1142 or the emergency services 1144. The presence-based security system 1100 may classify an event based on alarm signals from at least one of a smoke detector or a carbon monoxide detector. The presence-based security system 1100 may suppress, based on the threat level, an alert generated by the camera 1108.

The presence-based security system 1100 may receive video captured by the camera 1108 at a location and receive wireless signals captured using the RF sensors 1114. The method may include determining, using the wireless signals, that one or more wireless devices are present and determining, using a signal strength of the wireless signals, whether each wireless device is proximate to the camera 1108. The method may include generating presence information including whether each wireless device is a known wireless device and correlating the video and the presence information. The method may include determining, based on the correlating, whether to generate a notification to the user device 1140 and, based on determining whether to generate the notification, performing at least one action associated with the presence information.

Based on whether each wireless device is proximate to the camera 1108, an event associated with the location can be classified. Determining whether to generate the notification can be based on the event. Methods may include classifying, based on the correlating, an event associated with the location and controlling, based on the event, a smart device using the smart device control system 1134. Motion at the location can be detected based on perturbations in the wireless signals. Based on detecting the motion, a threat level is generated for the notification. A trend in the signal strength of the wireless signals can be analyzed. Based on the analyzing, it can be determined whether a wireless device is approaching or leaving the location. The correlating may comprise associating a number of persons depicted in the video with identifiers of wireless devices determined to be proximate to the camera 1108.

In an implementation, the presence-based security system 1100 may receive wireless signals emitted by a wireless device at a location and measure received signal strength indication (RSSI) values of the wireless signals over time using the RSSI analysis module 1118. The system 1100 may determine, based on a trend in the RSSI values, whether the wireless device is approaching the location or leaving the location and determine, based on the trend, a linger time of the wireless device at the location. The system may, based on at least one of whether the wireless device is approaching or leaving the location or the linger time, send a notification to the user device 1140.

The wireless signals may be captured by an RF sensor 1114, and the system may analyze the trend to determine a proximity of the wireless device to the RF sensor 1114. The system may determine, based on at least one of whether the wireless device is approaching or leaving the location or the linger time, a threat level for the notification. The system may control, based on the linger time, at least one connected device at the location using the smart device control system 1134. The system 1100 may determine that the wireless device is approaching the location when the trend in the RSSI values indicates that the RSSI values are increasing over time and determine that the wireless device is leaving the location when the trend in the RSSI values indicates that the RSSI values are decreasing over time. The trend in the RSSI values may be determined using a moving average of the RSSI values over a sliding time window.

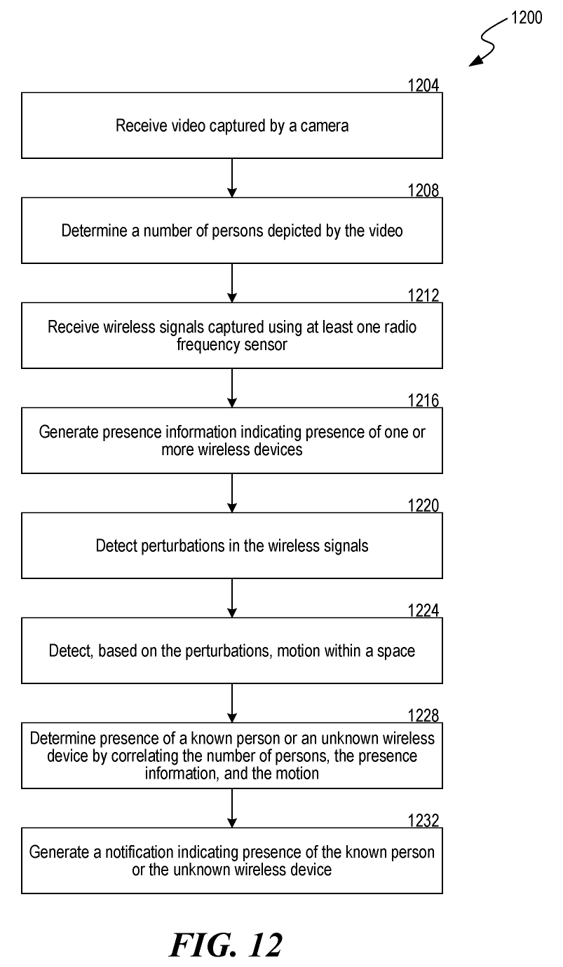

FIG. 12 is a flowchart illustrating an example process for correlating video-derived person counts with RF-based device presence and motion, according to aspects of the present disclosure. In some implementations, the process is performed by the system 1100 illustrated and described in more detail with reference to FIG. 11. In some implementations, the process is performed by a computer system, e.g., example computer system 1600 illustrated and described in more detail with reference to FIG. 16. Particular entities, for example, AI system 1500, perform some or all of the steps of the process in other implementations. The AI system 1500 is illustrated and described in more detail with reference to FIG. 15. Likewise, implementations can include different and/or additional steps or can perform the steps in different orders.

At 1204, a computer system receives video captured by a camera positioned at a monitored location. The camera may incorporate advanced features such as night vision capabilities, wide-angle lenses, or pan-tilt-zoom functionality to provide visual coverage of the monitored space. The captured video data can be transmitted in high-definition format, potentially including both visible light and infrared spectra for effective day and night operation. The video data may be digitized and compressed using advanced codecs to reduce storage requirements and improve transmission efficiency. The computer system processes this incoming video stream using a data aggregation module that harmonizes the visual input with other sensor data streams for subsequent analysis by the system's intelligence layer.

At 1208, the computer system determines a number of persons depicted by the video using computer vision algorithms and image processing techniques. A video processing module analyzes sequential video frames to identify human figures within the captured footage, potentially employing machine learning-based object detection and recognition capabilities. The system may utilize background subtraction, optical flow analysis, or artificial intelligence models to distinguish between individuals and other objects in the monitored space. The video processing module can apply various image enhancement techniques to improve visibility, especially in low-light conditions, enabling accurate person counting even during nighttime surveillance. This visual analysis provides quantitative data about human presence that can be correlated with other sensor inputs for security assessment.

At 1212, the computer system receives wireless signals captured using at least one sensor configured to detect various types of wireless transmissions. The sensors and receivers scan the electromagnetic spectrum within their coverage area, capturing probe requests, beacon frames, and other wireless transmissions emitted by devices carried by individuals. The sensing mechanisms may include thermal sensors, diode sensors, or calibrated sensors.

At 1216, the computer system generates presence information using the wireless signals, indicating that one or more wireless devices are present and identifying specific device identifiers. The device identification module processes the wireless signals detected by the sensors to extract unique identifiers. This information may be correlated with a database of known devices associated with authorized users, enabling the system to distinguish between familiar and unfamiliar wireless devices. The presence determination module analyzes signal characteristics including signal strength, frequency, and embedded device signatures to create presence profiles that can differentiate between known occupants, guests, and potential security threats within and around the monitored environment.

The computer system can identify an RSSI value in the wireless signals by measuring the power level of wireless transmissions detected by the sensors. The RSSI measurements provide quantitative data about signal amplitude that correlates with proximity relationships between wireless devices and specific sensor locations. Using the RSSI values, the system determines the location of one or more wireless devices by analyzing signal strength variations across multiple sensors positioned throughout the monitored space.

Machine learning algorithms may be employed to establish RSSI threshold boundaries that define localized presence zones around each sensor, enabling the system to distinguish between devices within the broader property coverage area versus those specifically proximate to particular sensor locations where security events occur. Proximate may be defined as wireless devices with RSSI values above -60 dBm relative to a camera-integrated sensor, or devices detected within a 10 m radius threshold distance from specific monitoring equipment locations.

The computer system can determine a trend in RSSI values of the wireless signals by monitoring temporal sequences of signal strength measurements from identified wireless devices over time. A trend in RSSI values may show increasing measurements from -80 dBm to -45 dBm over a 60-second period indicating device approach, or decreasing values from -40 dBm to -75 dBm indicating departure from the monitored area. The motion analysis module processes these RSSI measurements, applying signal processing algorithms and temporal filtering techniques to detect directional movement patterns relative to sensor positions. Using the trend analysis, the system determines that a wireless device is approaching or leaving the space by observing increasing RSSI values over time for approaching devices and decreasing signal strength measurements for departing devices. The system may utilize moving averages over sliding time windows and noise reduction techniques to distinguish genuine approach and departure patterns from random signal fluctuations caused by multipath propagation or environmental interference.

At 1220, the computer system detects perturbations in the wireless signals caused by objects or individuals moving within and around the monitored environment. The sensors sense disturbances in the ambient wireless field by measuring changes in signal characteristics including amplitude variations, phase shifts, frequency deviations, multipath reflections, signal attenuation, and propagation delays.

The computer system can classify an event associated with the space based on the correlation of video data, presence information, and motion detection using machine learning algorithms such as gradient-boosting decision trees to analyze patterns in the aggregated data. The event classification module categorizes detected events as normal behaviors, potential security threats, or anomalous events based on predefined rules or trained classification models. The system determines a threat level for the event based on the location of one or more wireless devices by analyzing proximity relationships, the number of unknown devices detected, timing and location within the property, and correlation strength between motion and device arrivals. The threat level assessment module incorporates risk analysis models and historical data patterns to assign appropriate urgency levels ranging from low to high threat classifications.

The event classification process can incorporate alarm signals from a smoke detector or a carbon monoxide detector as part of the alarm-based functionalities integrated within the presence-based security system. The sensors can detect these alarm signals, which are received by a data aggregation module and processed alongside other sensor inputs including wireless device data and video information. A correlation and sensor fusion module integrates this diverse alarm data with presence information, enabling an event classification module to contextualize potential security threats with environmental hazards. This approach enables the system to distinguish between different types of emergencies, such as differentiating between break-ins and fire or gas leak situations, thereby enhancing the accuracy and specificity of threat assessment and response generation capabilities.

The computer system can suppress an alert generated by the camera based on the determined threat level using intelligent event filtering and classification processes. When a correlation and sensor fusion module determines that detected motion corresponds to known wireless devices associated with authorized users, the system may classify the event as routine activity rather than a security threat. The threat level assessment module can evaluate the classified event in conjunction with presence information, and for low-threat scenarios involving known individuals, the system can automatically suppress camera alerts that would otherwise generate unnecessary notifications. This intelligent suppression capability reduces false alarms triggered by authorized occupants while maintaining high security effectiveness, enabling the system to provide more targeted and meaningful alerts to users and monitoring services only when genuine security concerns are identified.

At 1224, the computer system detects motion within or around a space based on the perturbations in wireless signals, leveraging the principle that moving objects cause measurable disturbances in the wireless environment. Motion may be detected using RSSI fluctuations of ±5 dBm indicating wireless signal perturbations, visual changes between video frames, or Doppler frequency shifts of 2-10 Hz in wireless signals caused by moving individuals. Signal processing algorithms can be used to analyze the perturbations in real-time, filtering out ambient noise and static objects to isolate patterns indicative of human movement. A motion analysis module can process temporal sequences of wireless measurements, applying signal processing techniques to distinguish genuine motion patterns from random signal fluctuations caused by multipath propagation or environmental interference. This RF-based motion detection capability operates effectively even through walls or in low-light conditions, providing a complementary layer of sensing alongside traditional motion detection technologies and enabling coverage of areas where visual surveillance might be limited or impractical.

At 1228, the computer system determines that a known person or an unknown wireless device is present by correlating the number of persons depicted by the video, the presence information, and the detected motion. The known person is associated with at least one identifier obtained from the wireless signals. For example, the computer system registers a user and their wireless devices in an account within a database associated with the monitored space by capturing and storing unique device identifiers. The registration process may involve the user connecting their devices to the system's network or manually adding device signatures through a mobile application interface, enabling a presence determination module to correlate detected wireless signals with authorized individuals. The database maintains associations between specific users and their registered devices, allowing a device identification module to compare newly detected wireless device signatures against stored authorized device profiles. Once registered, the system can distinguish the user as a known person when their associated wireless devices are detected within the monitored space, enabling personalized security responses and reducing false alarms.

The system can cross-reference detected wireless device signatures with a database of known devices linked to authorized users, while simultaneously analyzing the timing and location of both visual motion detection and RF-based device arrivals. This multi-layered correlation process enables the system to distinguish between motion caused by known individuals carrying recognized devices and potential security threats from unknown entities.

The computer system can generate a notification indicating that the known person and/or the unknown wireless device is present and sends the notification to a user device using the response management module. An alert generation module can create targeted notifications based on the classified events and threat assessments, which may be transmitted to property owners, security personnel, or designated contacts using multiple channels including mobile applications, text messages, or email. An event may include detection of an unknown wireless device at the front door, motion detected by cameras at 2:30 AM, or simultaneous arrival of three unrecognized devices triggering a potential security breach classification.

The notification may include contextual information such as video feeds, device identification details, and event classification data to provide users with situational awareness. A mobile device interface, implemented using a dedicated smartphone application, enables users to receive real-time alerts with push notifications, live video streaming, and interactive response options for immediate security management.

The computer system can generate a second notification indicating the unknown wireless device presence or the classified event using an alert generator component of a response management module. Based on the determined threat level, the system sends the second notification to a monitoring service or an emergency service, providing information about the security situation including video feeds, device identification details, and event classification data. For high-threat scenarios, the system may initiate direct communication with emergency services, transmitting relevant contextual information to enable appropriate response deployment. The notification system may interface with professional monitoring services using cloud-based security service providers or dedicated communication channels, facilitating rapid assessment and response coordination by trained personnel who can evaluate situations and dispatch emergency services when necessary.

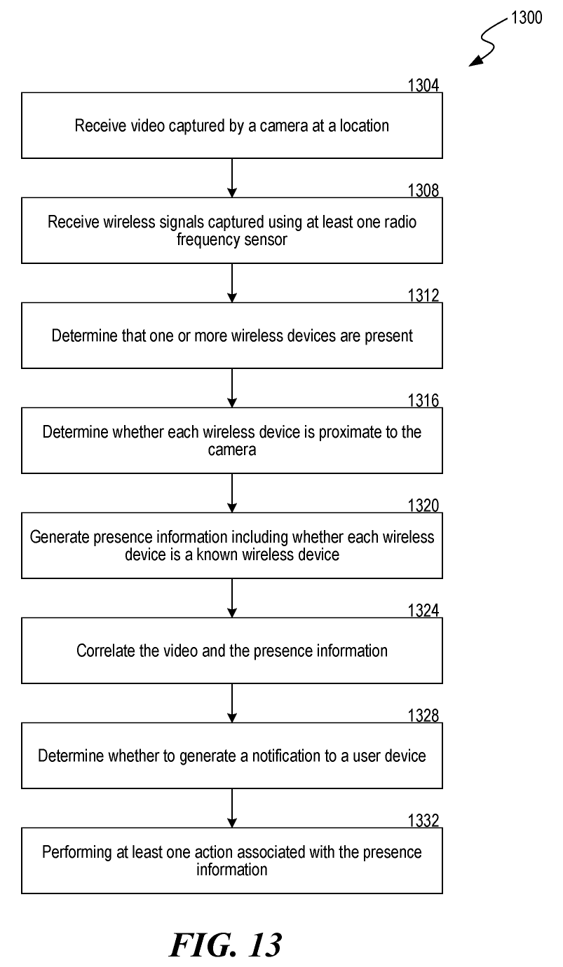

FIG. 13 is a flowchart illustrating an example process for proximity determinations based on signal strength, according to aspects of the present disclosure. In some implementations, the process is performed by the system 1100 illustrated and described in more detail with reference to FIG. 11. In some implementations, the process is performed by a computer system, e.g., example computer system 1600 illustrated and described in more detail with reference to FIG. 16. Particular entities, for example, AI system 1500, perform some or all of the steps of the process in other implementations. The AI system 1500 is illustrated and described in more detail with reference to FIG. 15. Likewise, implementations can include different and/or additional steps or can perform the steps in different orders.

At 1304, a computer system receives video captured by a camera at a location, where the camera may be positioned to provide visual coverage of the monitored space. The camera can incorporate advanced features such as night vision capabilities, wide-angle lenses, or pan-tilt-zoom functionality to capture high-definition video streams that may include both visible light and infrared spectra for effective day and night operation. The captured video data can be digitized and compressed using advanced codecs to reduce storage requirements and improve transmission efficiency. The computer system processes this incoming video stream using a data aggregation module that harmonizes the visual input with other sensor data streams, preparing the video data for subsequent analysis by the system's intelligence layer and video processing modules.

At 1308, the computer system receives wireless signals captured using at least one sensor configured to detect various types of wireless transmissions across multiple frequency bands. The sensors scan the electromagnetic spectrum within their coverage area, capturing probe requests, beacon frames, and other wireless transmissions emitted by devices carried by individuals entering or present within and around the monitored space. The sensing mechanisms may employ specialized antennas and signal processing hardware capable of detecting and analyzing a wide spectrum of signals, including thermal sensors, diode sensors, and calibrated sensors designed for wireless signal detection and characterization.

The system may utilize specialized antennas and signal processing hardware capable of analyzing this wide spectrum of signals, employing techniques such as Identity Resolving Keys for Bluetooth device identification and MAC address extraction from Wi-Fi transmissions. This wireless signal detection capability enables the system to identify and track multiple device types simultaneously, providing robust presence detection across diverse wireless communication protocols.

At 1312, the computer system determines that one or more wireless devices are present using the wireless signals by analyzing the characteristics of received wireless transmissions. A device identification module can process the wireless signals to extract unique identifiers. Signal processing algorithms can analyze the received signals to identify specific mobile devices that are present, even if they are not connected to the property's wireless network. The computer system can use machine learning algorithms to classify and identify different types of wireless devices, enabling the system to distinguish between various device categories and their typical behavior patterns. This detection capability provides foundational data for determining occupancy and identifying potential security threats within and around the monitored environment.

The computer system detects motion at the location based on perturbations in the wireless signals by sensing disturbances in the ambient wireless environment caused by moving objects or individuals within and around the monitored space. The sensors measure changes in signal characteristics including amplitude variations, phase shifts, frequency deviations, and multipath reflections that occur when human bodies, being composed largely of water, disrupt wireless signals. Signal processing algorithms analyze these perturbations in real-time, filtering ambient noise to identify patterns indicative of human movement. Based on detecting this RF-based motion, the system generates a threat level for notifications using the threat level assessment module, which evaluates motion patterns in conjunction with device identification and timing factors to assign appropriate urgency levels for security responses.

At 1316, the computer system determines whether each wireless device is proximate to the camera using signal strength measurements of the wireless signals, particularly RSSI values. The system analyzes RSSI measurements from detected wireless devices to establish proximity relationships between individuals and specific camera locations within and around the monitored space. Machine learning algorithms may be employed to establish RSSI threshold boundaries that define localized presence zones around each camera, enabling the system to distinguish between devices within and around the broader property coverage area versus those specifically proximate to the camera location where visual events occur. For example, RSSI threshold boundaries may be established at -50 dBm for immediate proximity within 2 m of a camera, -65 dBm for close proximity within 5 m, and -75 dBm for general presence within 15 m. Machine learning algorithms may adjust these thresholds based on environmental factors, with indoor boundaries typically 10-15 dBm higher than outdoor settings. This proximity determination capability enables the system to correlate physical presence near cameras with detected wireless devices, providing spatial context for security event analysis and enabling more accurate threat assessment based on localized device detection.

At 1320, the computer system generates presence information including whether each wireless device is a known wireless device by comparing detected device signatures against a database of authorized devices. The presence determination module processes wireless receiver data to identify unique device identifiers and correlates this information with historical data to recognize known devices associated with authorized users. The system maintains a database of known wireless devices linked to family members, authorized visitors, and residents, enabling it to distinguish between familiar and unfamiliar persons present within and around the monitored space. Machine learning algorithms may be used to improve accuracy over time, learning to distinguish between different types of presence scenarios and reducing false positives. This presence information generation process creates profiles that differentiate between known occupants, guests, and potential security threats based on wireless device identification and historical association patterns.

The computer system analyzes a trend in the signal strength of the wireless signals by monitoring temporal sequences of RSSI measurements from identified wireless devices over time using the motion analysis module. The system processes these RSSI values, applying signal processing algorithms and temporal filtering techniques to detect directional movement patterns relative to sensor positions, utilizing moving averages over sliding time windows to distinguish genuine trends from random fluctuations. Based on this trend analysis, the system determines whether a wireless device is approaching or leaving the location by observing increasing RSSI values over time for approaching devices and decreasing signal strength measurements for departing devices. Machine learning algorithms may be trained to recognize characteristic RSSI signature patterns associated with typical approach and departure behaviors, enabling accurate directional movement classification that provides contextual information for security event assessment.

At 1324, the computer system correlates the video and the presence information using a correlation and sensor fusion module, which synthesizes data from multiple sources using advanced analytical techniques. The module integrates visual motion detection data from cameras with wireless device presence information, analyzing the timing and location of both video-detected activities and RF-based device arrivals to establish relationships between physical movement and wireless device presence. The correlation enables the system to distinguish between motion caused by known individuals carrying recognized devices and potential security threats from unknown entities, providing context-aware analysis that enhances the accuracy of event classification and threat determination.

The computer system classifies an event associated with the location based on whether each wireless device is proximate to the camera using localized presence detection capabilities that utilize RSSI measurements to establish spatial relationships between devices and camera positions. The event classification module processes proximity data to categorize detected activities, distinguishing between events involving known devices near the camera versus unknown wireless devices in the vicinity. Machine learning algorithms may analyze proximity patterns and device identification data to classify events as routine activities, potential security threats, or anomalous behaviors. The determination of whether to generate a notification is based on this event classification, where events involving unknown devices proximate to cameras may trigger alerts while recognized authorized devices may result in notification suppression, enabling intelligent filtering that reduces false alarms.

At 1328, the computer system determines whether to generate a notification to a user device based on the correlation of video data and presence information using intelligent event classification and threat assessment processes. An event classification module analyzes the correlated data to categorize detected events as normal behaviors, potential security threats, or anomalous events using predefined rules or machine learning algorithms. A threat level assessment module evaluates classified events in conjunction with presence information, considering factors such as the identity of detected individuals, timing of events, and correlation strength between visual motion and device presence. For scenarios involving known individuals with recognized devices, the system may determine that notification generation is unnecessary, while unknown devices or suspicious activities may trigger alert generation. This decision-making process enables intelligent filtering that reduces false alarms such that genuine security concerns are promptly communicated to users.

The correlation process comprises associating a number of persons depicted in the video with identifiers of wireless devices determined to be proximate to the camera using sophisticated sensor fusion techniques implemented by the correlation and sensor fusion module. The system analyzes contemporaneous data streams from video processing modules that count individuals in camera feeds and RF-based device detection that identifies wireless device signatures within localized proximity zones around cameras. This association process correlates visual person counts with detected device identifiers such as MAC addresses or Bluetooth signatures, enabling the system to determine correspondence between physical individuals and their carried wireless devices. The correlation may utilize temporal synchronization and spatial analysis to match detected persons with proximate wireless devices, providing situational awareness that distinguishes between scenarios where person counts match device counts versus discrepancies that may indicate security concerns.

The computer system classifies an event associated with the location based on the correlation of video data and presence information using an event classification module, which analyzes aggregated inputs to categorize detected activities using predefined rules or machine learning algorithms. The classification process considers factors such as visual motion patterns, wireless device identification, timing relationships, and proximity data to distinguish between normal activities and potential security threats. Based on the classified event, the system controls a smart device using the device control module, which manages activation and deactivation of connected smart devices within the monitored space. For security events involving unknown presences, the system may automatically engage smart locks to secure entry points or activate smart lights as deterrent measures, providing automated physical security responses.

At 1332, the computer system performs at least one action associated with the presence information based on determining whether to generate the notification, implementing adaptive responses using the response management module. For scenarios requiring user notification, the system may send alerts to mobile devices, activate connected smart devices such as lights or locks, or contact emergency services depending on the assessed threat level. When notifications are suppressed due to recognized authorized presence, the system may log the activity for historical tracking or adjust smart home settings for known occupants. The adaptive response capabilities enable the system to control smart locks, activate deterrent lighting, generate audible alerts using connected speakers, or initiate two-way communication features. These automated actions are tailored to the specific context of detected presence, providing appropriate and proportional responses that enhance security effectiveness while maintaining user convenience and reducing unnecessary disruptions.

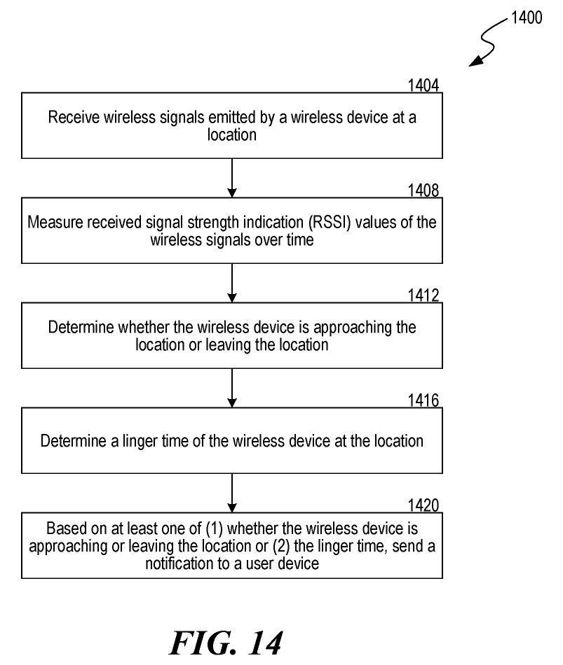

FIG. 14 is a flowchart illustrating an example process for analyzing RSSI trends of wireless signals to determine whether a device is approaching or leaving a location, according to aspects of the present disclosure. In some implementations, the process is performed by the system 1100 illustrated and described in more detail with reference to FIG. 11. In some implementations, the process is performed by a computer system, e.g., example computer system 1600 illustrated and described in more detail with reference to FIG. 16. Particular entities, for example, AI system 1500, perform some or all of the steps of the process in other implementations. The AI system 1500 is illustrated and described in more detail with reference to FIG. 15. Likewise, implementations can include different and/or additional steps or can perform the steps in different orders.

At 1404, a computer system receives wireless signals emitted by a wireless device at a location using wireless sensors or receivers configured to detect various types of wireless transmissions across multiple frequency bands. The wireless signals are captured by a sensor configured to detect various types of wireless transmissions across multiple frequency bands, and the system analyzes the trend to determine a proximity of the wireless device to the sensor using RSSI measurements that correlate signal strength with spatial relationships. The proximity determination can use machine learning algorithms to establish RSSI threshold boundaries that define localized presence zones around each sensor, enabling the system to distinguish between devices within different proximity ranges relative to the sensor position. Signal processing algorithms analyze temporal variations in RSSI values to assess how close wireless devices are to specific sensors, providing spatial context for security event analysis. This proximity analysis capability enables the system to create detailed spatial maps of device locations within and around the monitored environment, enhancing the accuracy of presence detection and enabling more precise threat assessment based on device positioning.

At 1408, the computer system measures RSSI values of the wireless signals over time using signal processing algorithms that quantify the power level of wireless transmissions detected by the sensors. The RSSI measurements provide temporal data about signal amplitude that correlates with proximity relationships between wireless devices and sensor locations, enabling the system to track signal strength variations as devices move within and around the monitored environment. A motion analysis module processes these RSSI measurements continuously or periodically, applying temporal filtering and noise reduction techniques to distinguish genuine signal strength changes from random fluctuations caused by multipath propagation or environmental interference.

At 1412, the computer system determines whether the wireless device is approaching the location or leaving the location based on a trend in the RSSI values by analyzing temporal sequences of signal strength measurements using directional movement detection algorithms. The system processes RSSI data over predetermined time windows, applying signal processing techniques to identify increasing RSSI trends that indicate device approach and decreasing signal strength patterns that signify device departure. Machine learning algorithms may be trained to recognize characteristic RSSI signature patterns associated with typical approach and departure behaviors, filtering out ambient noise and static objects to isolate movement patterns. The trend analysis may utilize moving averages over sliding time windows and statistical analysis techniques to quantify the strength and consistency of directional movement patterns, enabling accurate classification of device movement relative to the monitored location. Sliding time windows may range from 10 seconds to 5 minutes for RSSI trend analysis, with typical implementations using 30-second windows for approach detection, 2-minute windows for departure confirmation, and 60-second windows for motion pattern analysis. The system may employ overlapping windows with 15-second intervals to provide continuous temporal coverage.

The system determines that the wireless device is approaching the location when the trend in the RSSI values indicates increasing signal strength over time, and determines that the wireless device is leaving the location when the trend indicates decreasing RSSI values over time using directional movement detection algorithms. The approach detection process analyzes temporal sequences of RSSI measurements to identify consistent upward trends in signal strength that indicate devices moving closer to sensors, while departure detection identifies downward RSSI trends signifying movement away from the monitored location. Signal processing algorithms apply temporal filtering and noise reduction techniques to distinguish genuine directional movement patterns from random signal fluctuations caused by multipath propagation or environmental interference. This directional analysis provides contextual information that enhances the system's ability to assess the nature and urgency of detected security events, particularly when combined with visual motion detection and device identification data.

The trend in the RSSI values is determined using a moving average of the RSSI values over a sliding time window, which provides smoothed signal strength data that reduces the impact of short-term fluctuations and environmental noise on movement pattern analysis. The moving average calculation processes RSSI measurements across predetermined time periods, potentially ranging from 30 seconds to several minutes, to establish consistent trend patterns that accurately reflect device movement direction. This temporal smoothing technique enables the system to distinguish between genuine approach and departure behaviors versus temporary signal variations caused by obstacles, interference, or normal wireless propagation characteristics. The sliding time window approach enables continuous trend analysis that adapts to changing signal conditions while maintaining sensitivity to actual device movement patterns, providing reliable directional movement detection for security event classification and threat assessment processes.

At 1416, the computer system determines a linger time of the wireless device at the location based on the trend analysis by measuring the duration that RSSI values remain above predetermined threshold levels indicating sustained proximity. A linger time may range from 30 seconds for brief interactions to 15 minutes for extended presence, with thresholds such as 5 minutes triggering alerts for unknown devices or 2 hours for authorized occupancy tracking.

The system analyzes temporal patterns in signal strength data to identify periods when wireless devices maintain relatively stable RSSI measurements within defined proximity zones around sensors, indicating that individuals are remaining in specific areas for extended periods. The linger time calculation may incorporate signal processing algorithms that account for normal RSSI fluctuations while identifying sustained presence patterns that exceed baseline movement variations. This temporal analysis capability enables the system to distinguish between brief transitory movements and prolonged occupancy, providing contextual information about device behavior patterns that can be used for security event classification and threat assessment in conjunction with other sensor data.

At 1420, the computer system sends a notification to a user device based on whether the wireless device is approaching or leaving the location or the determined linger time, e.g., using an alert generator component of a response management module. The notification system evaluates approach and departure patterns along with linger time data to determine appropriate alert generation, where extended linger times or suspicious approach patterns may trigger security notifications while normal departure activities may result in routine logging. The system may send targeted notifications using multiple channels including mobile applications, text messages, or email, providing users with contextual information about device movement patterns and timing data. The adaptive notification capability enables intelligent filtering based on movement analysis and temporal behavior, such that users receive meaningful alerts about potentially concerning activities while avoiding unnecessary notifications for routine authorized movements within and around the monitored space.

The system can determine a threat level for the notification based on at least one of whether the wireless device is approaching or leaving the location or the linger time using the threat level assessment module, which evaluates movement patterns and temporal behavior using multi-factor risk assessment algorithms. The threat assessment process considers approach patterns as potentially higher risk compared to departure activities, while extended linger times may indicate suspicious loitering behavior that warrants elevated security responses. Machine learning models trained on historical event data may be used to predict potential outcomes and assign appropriate threat levels ranging from low to high urgency based on movement direction and duration patterns. The threat level determination incorporates contextual factors such as timing, location within the property, and correlation with other sensor inputs to provide risk evaluation that enables proportional security responses.

The system can control at least one connected device at the location based on the linger time using the device control module, which manages activation and deactivation of smart devices within the monitored space according to temporal behavior patterns. Extended linger times may trigger automated responses such as activating deterrent lighting, engaging smart locks to secure entry points, or initiating audible alerts using connected speakers to address potentially suspicious loitering behavior. The system may also adjust smart home automation settings based on linger time patterns, such as maintaining lighting or climate control for extended occupancy periods by authorized users. This temporal-based device control capability enables adaptive responses that account for both security concerns from unknown devices with unusual linger patterns and convenience features for recognized authorized devices with normal occupancy behaviors.

FIG. 15 is a block diagram that illustrates an example AI system 1500 that can implement aspects of the present technology. The AI system 1500 is implemented using components of the example computer system 1600 illustrated and described in more detail with reference to FIG. 16. For example, the AI system 1500 can be implemented using the processor 1602 and instructions 1608 programmed in the memory 1606 illustrated and described in more detail with reference to FIG. 16. Likewise, implementations of the AI system 1500 can include different and/or additional components or be connected in different ways.

As shown, the AI system 1500 can include a set of layers, which conceptually organize elements within an example network topology for the AI system's architecture to implement a particular AI model 1530. Generally, an AI model 1530 is a computer-executable program implemented by the AI system 1500 that analyzes data to make predictions. Information can pass through each layer of the AI system 1500 to generate outputs for the AI model 1530. The layers can include a data layer 1502, a structure layer 1504, a model layer 1506, and an application layer 1508. The algorithm 1516 of the structure layer 1504 and the model structure 1520 and model parameters 1522 of the model layer 1506 together form the example AI model 1530. The optimizer 1526, loss function engine 1524, and regularization engine 1528 work to refine and optimize the AI model 1530, and the data layer 1502 provides resources and support for application of the AI model 1530 by the application layer 1508.

The data layer 1502 acts as the foundation of the AI system 1500 by preparing data for the AI model 1530. As shown, the data layer 1502 can include two sub-layers: a hardware platform 1510 and one or more software libraries 1512. The hardware platform 1510 can be designed to perform operations for the AI model 1530 and include computing resources for storage, memory, logic, and networking, such as the resources described in relation to FIG. 16. The hardware platform 1510 can process amounts of data using one or more servers. The servers can perform backend operations such as matrix calculations, parallel calculations, machine learning (ML) training, and the like. Examples of servers used by the hardware platform 1510 include central processing units (CPUs) and graphics processing units (GPUs). In some instances, the hardware platform 1510 can include Infrastructure as a Service (IaaS) resources, which are computing resources, (e.g., servers or memory) offered by a cloud services provider. The hardware platform 1510 can also include computer memory for storing data about the AI model 1530, application of the AI model 1530, and training data for the AI model 1530. The computer memory can be a form of random-access memory (RAM), such as dynamic RAM, static RAM, and non-volatile RAM.

The software libraries 1512 can be thought of as suites of data and programming code, including executables, used to control the computing resources of the hardware platform 1510. The programming code can include low-level primitives (e.g., fundamental language elements) that form the foundation of one or more low-level programming languages, such that servers of the hardware platform 1510 can use the low-level primitives to conduct specific operations. The low-level programming languages do not require much, if any, abstraction from a computing resource's instruction set architecture, enabling them to run quickly with a small memory footprint. Examples of software libraries 1512 that can be included in the AI system 1500 include Intel Math Kernel Library, Nvidia cuDNN, Eigen, and Open BLAS.

The structure layer 1504 can include a machine learning (ML) framework 1514 and an algorithm 1516. The machine learning framework 1514 can be thought of as an interface, library, or tool that enables users to build and deploy the AI model 1530. The machine learning framework 1514 can include an open-source library, an API, a gradient-boosting library, an ensemble method, and/or a deep learning toolkit that work with the layers of the AI system facilitate development of the AI model 1530. For example, the machine learning framework 1514 can distribute processes for application or training of the AI model 1530 across multiple resources in the hardware platform 1510. The machine learning framework 1514 can also include a set of pre-built components that have the functionality to implement and train the AI model 1530 and enable users to use pre-built functions and classes to construct and train the AI model 1530. Thus, the machine learning framework 1514 can be used to facilitate data engineering, development, hyperparameter tuning, testing, and training for the AI model 1530.

Examples of machine learning frameworks 1514 or libraries that can be used in the AI system 1500 include TensorFlow, PyTorch, Scikit-Learn, Keras, and Cafffe. Random Forest is a machine learning algorithm that can be used within the machine learning frameworks 1514. LightGBM is a gradient boosting framework/algorithm (a machine learning technique) that can be used. Other techniques/algorithms that can be used are XGBoost, CatBoost, etc. Amazon Web Services is a cloud service provider that offers various machine learning services and tools (e.g., Sage Maker) that can be used for platform building, training, and deploying machine learning models. In some embodiments, the machine learning framework 1514 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 1500. For example, the machine learning framework 1514 can use a cascade of multiple layers of nonlinear processing units for implicit feature extraction and transformation. Each successive layer uses the output from the previous layer as input. The AI model 1530 can thus learn in supervised (e.g., classification) and/or unsupervised (e.g., pattern analysis) modes. The AI model 1530 can learn multiple levels of representations that correspond to different levels of abstraction, wherein the different levels form a hierarchy of concepts. In this manner, AI model 1530 can be configured to differentiate features of interest from background features.

The algorithm 1516 can be an organized set of computer-executable operations used to generate output data from a set of input data and can be described using pseudocode. The algorithm 1516 can include complex code that enables the computing resources to learn from new input data and create new/modified outputs based on what was learned. In some implementations, the algorithm 1516 can build the AI model 1530 through being trained while running computing resources of the hardware platform 1510. This training enables the algorithm 1516 to make decisions without being explicitly programmed to do so. Once trained, the algorithm 1516 can run at the computing resources as part of the AI model 1530 to make predictions or decisions, improve computing resource performance, or perform tasks. The algorithm 1516 can be trained using supervised learning, unsupervised learning, semi-supervised learning, and/or reinforcement learning.

Using supervised learning, the algorithm 1516 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. The user may label the training data based on one or more classes and trains the AI model 1530 by inputting the training data to the algorithm 1516. The algorithm determines how to label the new data based on the labeled training data. The user can facilitate collection, labeling, and/or input via the machine learning framework 1514. In some instances, the user may convert the training data to a set of feature vectors for input to the algorithm 1516. Once trained, the user can evaluate the algorithm 1516 on new data to determine if the algorithm 1516 is predicting accurate labels for the new data. For example, the user can use cross-validation methods to evaluate the accuracy of the algorithm 1516 and retrain the algorithm 1516 on new training data if the results of the cross-validation are less than an accuracy threshold.

Supervised learning can involve classification and/or regression. Classification techniques involve teaching the algorithm 1516 to identify a category of new observations based on training data and are used when input data for the algorithm 1516 is discrete. Said differently, when learning using classification techniques, the algorithm 1516 receives training data labeled with categories (e.g., types, makes, and models of devices) and determines how features observed in the training data (e.g., MAC addresses) relate to the categories. Once trained, the algorithm 1516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 1516 is continuous. Regression techniques can be used to train the algorithm 1516 to predict or forecast relationships between variables. To train the algorithm 1516 using regression techniques, a user can select a regression method for estimating the parameters of the model. The user collects and labels training data that is input to the algorithm 1516 such that the algorithm 1516 is trained to understand the relationship between data features and the dependent variable(s). Once trained, the algorithm 1516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 1516 learns patterns from unlabeled training data. In particular, the algorithm 1516 is trained to learn hidden patterns and insights of input data, which can be used for data exploration or for generating new data. Here, the algorithm 1516 does not have a predefined output, unlike the labels output when the algorithm 1516 is trained using supervised learning. Another way unsupervised learning is used to train the algorithm 1516 to find an underlying structure of a set of data is to group the data according to similarities and represent that set of data in a compressed format. The systems disclosed herein can use unsupervised learning to identify patterns in data received from a Wi-Fi receiver and so forth.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with similarities remain in a group that has less or no similarities to another group. Examples of clustering techniques density-based methods, hierarchical based methods, partitioning methods, and grid-based methods. In one example, the algorithm 1516 may be trained to be a k-means clustering algorithm, which partitions n observations in k clusters such that each observation belongs to the cluster with the nearest mean serving as a prototype of the cluster. Anomaly detection techniques are used to detect unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 1516 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 1516 include factor analysis, item response theory, latent profile analysis, and latent class analysis.

In some embodiments, the AI system 1500 trains the algorithm 1516 of AI model 1530, based on the training data, to correlate the feature vector to expected outputs in the training data. As part of the training of the AI model 1530, the AI system 1500 forms a training set of features and training labels by identifying a positive training set of features that have been determined to have a desired property in question, and, in some embodiments, forms a negative training set of features that lack the property in question. The AI system 1500 applies machine learning framework 1514 to train the AI model 1530, that when applied to the feature vector, outputs indications of whether the feature vector has an associated desired property or properties, such as a probability that the feature vector has a particular Boolean property, or an estimated value of a scalar property. The AI system 1500 can further apply dimensionality reduction (e.g., via linear discriminant analysis (LDA), PCA, or the like) to reduce the amount of data in the feature vector to a smaller, more representative set of data.

The model layer 1506 implements the AI model 1530 using data from the data layer and the algorithm 1516 and machine learning framework 1514 from the structure layer 1504, thus enabling decision-making capabilities of the AI system 1500. The model layer 1506 includes a model structure 1520, model parameters 1522, a loss function engine 1524, an optimizer 1526, and a regularization engine 1528.

The model structure 1520 describes the architecture of the AI model 1530 of the AI system 1500. The model structure 1520 defines the complexity of the pattern/relationship that the AI model 1530 expresses. Examples of structures that can be used as the model structure 1520 include decision trees, support vector machines, regression analyses, Bayesian networks, Gaussian processes, genetic algorithms, and artificial neural networks (or, simply, neural networks). The model structure 1520 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 1520 may include one or more hidden layers of nodes between the input and output layers. The model structure 1520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 1522 represent the relationships learned during training and can be used to make predictions and decisions based on input data. The model parameters 1522 can weight and bias the nodes and connections of the model structure 1520. For instance, when the model structure 1520 is a neural network, the model parameters 1522 can weight and bias the nodes in each layer of the neural networks, such that the weights determine the strength of the nodes and the biases determine the thresholds for the activation functions of each node. The model parameters 1522, in conjunction with the activation functions of the nodes, determine how input data is transformed into desired outputs. The model parameters 1522 can be determined and/or altered during training of the algorithm 1516.

The loss function engine 1524 can determine a loss function, which is a metric used to evaluate the AI model's 1530 performance during training. For instance, the loss function engine 1524 can measure the difference between a predicted output of the AI model 1530 and the actual output of the AI model 1530 and is used to guide optimization of the AI model 1530 during training to minimize the loss function. The loss function may be presented via the machine learning framework 1514, such that a user can determine whether to retrain or otherwise alter the algorithm 1516 if the loss function is over a threshold. In some instances, the algorithm 1516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 1526 adjusts the model parameters 1522 to minimize the loss function during training of the algorithm 1516. In other words, the optimizer 1526 uses the loss function generated by the loss function engine 1524 as a guide to determine what model parameters lead to the most accurate AI model 1530. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 1526 used may be determined based on the type of model structure 1520 and the size of data and the computing resources available in the data layer 1502.

The regularization engine 1528 executes regularization operations. Regularization is a technique that prevents over- and under-fitting of the AI model 1530. Overfitting occurs when the algorithm 1516 is overly complex and too adapted to the training data, which can result in poor performance of the AI model 1530. Underfitting occurs when the algorithm 1516 is unable to recognize even basic patterns from the training data such that it cannot perform well on training data or on validation data. The regularization engine 1528 can apply one or more regularization techniques to fit the algorithm 1516 to the training data properly, which helps constraint the resulting AI model 1530 and improves its ability for generalized application. Examples of regularization techniques include lasso (L1) regularization, ridge (L2) regularization, and elastic (L1 and L2 regularization).

In some embodiments, the AI system 1500 can include a feature extraction module implemented using components of the example computer system 1600 illustrated and described in more detail with reference to FIG. 15. In some embodiments, the feature extraction module extracts a feature vector from input data. The feature vector includes n features (e.g., feature a, feature b, . . ., feature n). The feature extraction module reduces the redundancy in the input data, e.g., repetitive data values, to transform the input data into the reduced set of features such as feature vector. The feature vector contains the relevant information from the input data, such that events or data value thresholds of interest can be identified by the AI model 1530 by using this reduced representation. In some example embodiments, the following dimensionality reduction techniques are used by the feature extraction module: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

The application layer 1508 describes how the AI system 1500 is used to solve problems or perform tasks. In an example implementation, the application layer 1508 can include instructions executed by the system 100 illustrated and described in more detail with reference to FIG. 1.

FIG. 16 is a block diagram that illustrates an example computer system 1600 in which at least some operations described herein can be implemented. As shown, the computer system 1600 can include: one or more processors 1602, main memory 1606, non-volatile memory 1610, a network interface device 1612, video display device 1618, an input/output device 1620, a control device 1622 (e.g., keyboard and pointing device), a drive unit 1624 that includes a storage medium 1626, and a signal generation device 1630 that are communicatively connected to a bus 1616. The bus 1616 represents one or more physical buses and/or point-to-point connections that are connected by appropriate bridges, adapters, or controllers. Various common components (e.g., cache memory) are omitted from FIG. 16 for brevity. Instead, the computer system 1600 is intended to illustrate a hardware device on which components illustrated or described relative to the examples of the figures and any other components described in this specification can be implemented.

The computer system 1600 can take any suitable physical form. For example, the computer system 1600 can share a similar architecture as that of a server computer, personal computer (PC), tablet computer, mobile telephone, game console, music player, wearable electronic device, network-connected ("smart") device (e.g., a television or home assistant device), AR/VR systems (e.g., head-mounted display), or any electronic device capable of executing a set of instructions that specify action(s) to be taken by the computer system 1600. In some implementations, the computer system 1600 can be an embedded computer system, a system-on-chip (SOC), a single-board computer system (SBC) or a distributed system such as a mesh of computer systems or include one or more cloud components in one or more networks. Where appropriate, one or more computer systems 1600 can perform operations in real-time, near real-time, or in batch mode.

The network interface device 1612 enables the computer system 1600 to mediate data in a network 1614 with an entity that is external to the computer system 1600 using any communication protocol supported by the computer system 1600 and the external entity. Examples of the network interface device 1612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1606, non-volatile memory 1610, machine-readable medium 1626) can be local, remote, or distributed. Although shown as a single medium, the machine-readable medium 1626 can include multiple media (e.g., a centralized/distributed database and/or associated caches and servers) that store one or more sets of instructions 1628. The machine-readable (storage) medium 1626 can include any medium that is capable of storing, encoding, or carrying a set of instructions for execution by the computer system 1600. The machine-readable medium 1626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as "computer programs"). The computer programs typically comprise one or more instructions (e.g., instructions 1604, 1608, 1628) set at various times in various memory and storage devices in computing device(s). When read and executed by the processor 1602, the instruction(s) cause the computer system 1600 to perform operations to execute elements involving the various aspects of the disclosure.

We claim:

1. A presence-based security system comprising:
at least one computer processor; and
a non-transitory computer-readable storage medium storing instructions that, when executed by the at least one computer processor, cause the presence-based security system to:
receive video captured by a camera;
determine a number of persons depicted by the video;
receive wireless signals captured using at least one sensor;
generate, using the wireless signals, presence information indicating (1) that one or more wireless devices are present and (2) one or more identifiers of the one or more wireless devices;
detect perturbations in the wireless signals;
detect, based on the perturbations, motion within a space;
determine that at least one of a known person or an unknown wireless device is present by correlating the number of persons depicted by the video, the presence information, and the motion,
wherein the known person is associated with at least one identifier;
generate a notification indicating that at least one of the known person or the unknown wireless device is present; and
send the notification to a user device.

2. The presence-based security system of claim 1, wherein the instructions cause the presence-based security system to:
determine, from the wireless signals, a received signal strength indicator (RSSI); and
determine, using the RSSI, a location of the one or more wireless devices.

3. The presence-based security system of claim 1, wherein the instructions cause the presence-based security system to:
determine a trend in RSSI values of the wireless signals; and
determine, using the trend, that a wireless device is approaching or leaving the space.

4. The presence-based security system of claim 1, wherein the instructions cause the presence-based security system to:
classify, based on said correlating, an event associated with the space;
determine a threat level for the event based on a location of the one or more wireless devices.

5. The presence-based security system of claim 4, wherein the instructions cause the presence-based security system to:
generate a second notification indicating at least one of (1) the unknown wireless device is present or (2) the event; and
send, based on the threat level, the second notification to at least one of a monitoring service or an emergency service.

6. The presence-based security system of claim 4, wherein the event is classified based on alarm signals from at least one of a smoke detector or a carbon monoxide detector.

7. The presence-based security system of claim 4, wherein the instructions cause the presence-based security system to:
suppress, based on the threat level, an alert generated by the camera.

8. A method comprising:
receiving video captured by a camera at a location;
receiving wireless signals captured using at least one radio frequency sensor;
determining, using the wireless signals, that one or more wireless devices are present;
determining, using a signal strength of the wireless signals, whether each wireless device is proximate to the camera;
generating presence information including whether each wireless device is a known wireless device;
correlating the video and the presence information;
determining, based on said correlating, whether to generate a notification to a user device; and
based on determining whether to generate the notification, performing at least one action associated with the presence information.

9. The method of claim 8, comprising:
classifying, based on whether each wireless device is proximate to the camera, an event associated with the location,
wherein determining whether to generate the notification is based on the event.

10. The method of claim 8, comprising:
classifying, based on said correlating, an event associated with the location; and
controlling, based on the event, at least one of a smart light or a smart lock.

11. The method of claim 8, wherein the wireless signals comprise at least one of Wi-Fi signals, Bluetooth signals, cellular signals, or Zigbee signals.

12. The method of claim 8, comprising:
detecting motion at the location based on perturbations in the wireless signals; and
generating, based on detecting the motion, a threat level for the notification.

13. The method of claim 8, comprising:
analyzing a trend in the signal strength of the wireless signals; and
determining, based on said analyzing, whether a wireless device is approaching or leaving the location.

14. The method of claim 8, wherein said correlating comprises associating a number of persons depicted in the video with identifiers of wireless devices determined to be proximate to the camera.

15. A non-transitory, computer-readable storage medium comprising instructions recorded thereon, wherein the instructions, when executed by at least one data processor of a system, cause the system to:
receive wireless signals emitted by a wireless device at a location;
measure received signal strength indication (RSSI) values of the wireless signals over time;
determine, based on a trend in the RSSI values, whether the wireless device is approaching the location or leaving the location;
determine, based on the trend, a linger time of the wireless device at the location; and
based on at least one of (1) whether the wireless device is approaching or leaving the location or (2) the linger time, send a notification to a user device.

16. The non-transitory, computer-readable storage medium of claim 15, wherein the wireless signals are captured using a radio frequency (RF) sensor, and
wherein the system is caused to:
analyze the trend to determine a proximity of the wireless device to the RF sensor.

17. The non-transitory, computer-readable storage medium of claim 15, wherein the system is caused to:
determine, based on at least one of (1) whether the wireless device is approaching or leaving the location or (2) the linger time, a threat level for the notification.

18. The non-transitory, computer-readable storage medium of claim 15, wherein the system is caused to:
control, based on the linger time, at least one connected device at the location.

19. The non-transitory computer-readable storage medium of claim 15, wherein the system is caused to:
determine that the wireless device is approaching the location when the trend in the RSSI values indicates that the RSSI values are increasing over time; and
determine that the wireless device is leaving the location when the trend in the RSSI values indicates that the RSSI values are decreasing over time.

20. The non-transitory computer-readable storage medium of claim 19, wherein the trend in the RSSI values is determined using a moving average of the RSSI values over a sliding time window.
